(19) United States
(12) Patent Application Publication
(10) Pub. No.: US 2014/0063466 A1
(43) Pub. Date: Mar. 6, 2014

(54) PROJECTION APPARATUS

(71) Applicant: Sony Corporation, Tokyo (JP)

(72) Inventor: Keisuke Homma, Kanagawa (JP)

(73) Assignee: Sony Corporation, Tokyo (JP)

(21) Appl. No.: 13/974,386

(22) Filed: Aug. 23, 2013

(30) Foreign Application Priority Data
Aug. 30, 2012 (JP) 2012-189863

(51) Int. Cl. G03B 21/20

(52) U.S. Cl. CPC G03B 21/2073
USPC 353/20

(57) ABSTRACT

A projection apparatus includes a color synthesis section, a polarization conversion section, and a projection lens. The color synthesis section is configured to combine light in three primary colors of red light, green light, and blue light and emit combined light. The polarization, conversion section includes a first polarization conversion member having a slow axis with an angle other than angles of 0°, 90°, 180°, and 270°, and a second polarization conversion member having a slow axis with an angle that is opposite, to the slow axis of the first polarization conversion member by 180°. The projection lens is configured to emit light output from the polarization conversion section.

### BACKGROUND

The present disclosure relates to a projection apparatus that performs a video display.

There has recently developed an LCD (Liquid Crystal Display) projector adopting the 3D (three-dimensional) active shutter technology. The active shutter technology belongs to the video display technology with which a sense of depth is created. With such an active shutter technology, stereoscopic viewing is achieved with parallax, which is created by alternately displaying a left-eye picture and a right-eye picture and, in synchronization with switching of the pictures, alternately blocking right and left eyes view of 3D glasses.

The issue here is that such a projector projecting 3D images as described above has a difficulty in quality control compared with a projector projecting 2D (two-dimensional) images. This is because, as for light polarized after reflection on a screen, the 3D glasses transmit only components polarized in a specific direction, and this polarization state greatly affects the quality of the 3D images, i.e., causes color unevenness, and reduction of brightness.

When images displayed as 2D images are viewed, the 3D glasses are not used. Therefore, the image quality is not affected by the polarization state of light after reflection on the screen because the light enters observer's eyes uniformly irrespective of the polarization state. On the other hand, in an LCD projector or others adopting the 3D active shutter technology, an important factor is to give consideration to the polarization state of light before the light reaches the 3D glasses.

Japanese Patent Application Laid-open No. 2007-304607 proposes a projection display apparatus that equalizes the ratio of light quantity in a horizontal direction to light quantity in a vertical direction among each color of RGB (Red, Green, and Blue).

### SUMMARY

With a projector in related art that displays 3D images, however, before projection light therefrom reaches the 3D glasses after being reflected on the screen, no appropriate polarization conversion processing for improving the quality of the 3D images is performed on the light. There thus is a problem that when the 3D glasses are not tilted, color unevenness is perceived in the 3D images. Further, there is another problem that when the 3D glasses are tilted, not only color unevenness but also brightness reduction are perceived in the 3D images.

In addition, even in the case where a projector referred to as a “short focus projector”, in which a projection distance to a screen is short, and a screen other than a “diffusive” screen having reflection characteristics are used, the color unevenness or brightness reduction occurs. The diffusive screen refers to a screen that uniformly diffuses and reflects incoming light without deviation. Examples of screens other than the diffusive screen include a silver screen that maintains polarization characteristics of projection light and a whiteboard.

The short focus projector is used at a position very close to the screen. In many cases, the short focus projector is disposed on a desk with the height almost equal to the height of the bottom side of the screen, or disposed at the height almost equal to the height of the top side of the screen while being suspended from the ceiling. When projection is performed onto the screen from the short focus projector in such a mode, the projection light enters the surface of the screen in an oblique direction. In such a case, in a non-diffusive screen, a reflection ratio differs between S-polarized light and P-polarized light. Further, also in the vicinity of the bottom side and the top side of the screen, reflection ratios thereof are largely deviated. Such a deviation of the polarization state on the screen surface is recognized as color unevenness by an observer.

In order to solve such a problem, there is conceived a method of disposing a polarization conversion section between a color synthesis section and a projection lens, the color synthesis section producing combined light from light in three primary colors, or on the light-emission side of the projection lens. The polarization conversion section is formed of a uniaxial crystal and the like having one optic axis (also referred to as optical axis). When the polarization conversion section is formed of a uniaxial crystal, a uniaxial organic material, or a wavelength-selective half-wave plate that shifts a phase by π with respect to a predetermined, wavelength, the polarization state of the light in three primary colors that is generated in the color synthesis section is converted into a non-polarized state that is uniform in all directions.

Thus, the polarization state of light that is emitted from the polarization conversion section onto the screen through the projection lens is also converted into the non-polarized state. Therefore, the color unevenness of 3D images when the 3D glasses are not tilted and the color unevenness and brightness reduction of 3D images when the 3D glasses are tilted can be completely eliminated. Similarly, the color unevenness caused by using a short focus projector and a non-diffusive screen can also be eliminated.

In the case where the polarization conversion section is formed of the uniaxial crystal or the uniaxial organic material, however, a phenomenon that an image projected onto the screen seems like being reduplicated is caused, and thus the resolution is lowered. This is because light emitted from the color synthesis section or the projection lens passes through the polarization conversion section and is separated into an ordinary ray and an extraordinary ray. Further, in the case where the polarization conversion section is formed of the uniaxial organic material or the wavelength-selective half-wave plate, wave front aberrations are added, to wave fronts of light because of the characteristics of those organic materials. Thus, the image projected onto the screen is seen like being blurred.

The present disclosure has been made in view of the circumstances as described above, and it is desirable to improve the quality of 2D images and 3D images without impairing the resolution thereof.

According to an embodiment of the present disclosure, there is provided a projection apparatus including a color synthesis section, a polarization conversion section, and a projection lens. The color synthesis section is configured to combine light in three primary colors of red light, green light, and blue light and emit combined light. The polarization conversion section includes a first polarization conversion member having a slow axis with an angle other than angles of 0°, 90°, 180°, and 270°, and a second polarization conversion member having a slow axis with an angle that is opposite to the slow axis of the first polarization conversion member by 180°, The projection lens is configured to emit light output from the polarization conversion section.

With this configuration, the polarized light in a wavelength of each color light in the combined light emitted from the color synthesis section is converted into polarized, light different for each wavelength by the first polarization conversion member of the polarization conversion section. Further, the light separated into two by passing through the first polarization conversion member is integrated as one light again by passing through the second polarization, conversion member. Thus, the color unevenness and brightness reduction of 3D images and the color unevenness of 2D images can be eliminated without impairing the resolution of the image to be projected onto a screen or the like.

According to the present disclosure, the quality of 2D images and that of 3D images can be considerably improved.

These and other objects, features and advantages of the present disclosure will become more apparent, in light of the following detailed description of best mode embodiments thereof, as illustrated in the accompanying drawings.

### BRIEF DESCRIPTION OF DRAWINGS

FIG. 1 is a perspective view showing a schematic exemplary configuration of a projection apparatus according to an embodiment of the present disclosure;

FIGS. 2A and 2B are explanatory views showing an arrangement example of a polarization conversion section with respect to a color synthesis prism according to the embodiment of the present disclosure, FIG. 2A being a side view, FIG. 2B being a top view;

FIGS. 3A and 3B are explanatory views showing a setting example of a slow axis of a first polarization conversion member according to the embodiment of the present disclosure, FIG. 3A showing the case where an oscillation direction of light entering the first polarization conversion member is a vertical direction, FIG. 3B showing the case where the oscillation direction of the light entering the first polarization conversion member is a horizontal direction;

FIGS. 4A and 4B are perspective views each showing a schematic exemplary configuration in the case where a polarization conversion member formed of a uniaxial crystal is disposed on a light-emission side of the color synthesis prism, FIG. 4A showing an exemplary configuration, FIG. 4B showing an image projected from the projection apparatus onto a screen;

FIGS. 5A and 5B are perspective views each showing a schematic exemplary configuration of the projection apparatus according to the embodiment of the present disclosure, FIG. 5A showing an exemplary configuration, FIG. 5B showing an image projected from the projection apparatus onto the screen;

FIG. 6 is a diagram showing factors that change the polarization state of light;

FIG. 7 is a diagram showing color unevenness perceived via 3D glasses;

FIG. 8 is another diagram showing color unevenness perceived via the 3D glasses;

FIG. 9 is a diagram showing an exemplary configuration of an optical unit of a transmissive LCD (Liquid Crystal Display) projector according to the embodiment of the present disclosure;

FIG. 10 is a diagram showing an exemplary configuration of an optical unit of a reflective LCD projector according to the embodiment of the present disclosure;

FIGS. 11A, 11B, and 11C are explanatory diagrams for describing the characteristics of the uniaxial crystal, FIG. 11A showing a case where a slow axis has an angle of 45° with respect to an amplitude direction of incoming polarized light, FIG. 11B showing a case where the slow axis has an angle of 0° or 90° with respect to the amplitude direction of the incoming polarized light, FIG. 11C showing a case where the slow axis has an angle other than 0°, 45°, and 90° with respect to the amplitude direction of the incoming polarized light;

FIG. 12 is a diagram showing a polarization state of light by a phase difference of the uniaxial crystal;

FIG. 13 is a diagram showing an exemplary configuration of a projection apparatus according to an arrangement pattern 1 of the embodiment of the present disclosure;

FIG. 14 is a diagram showing another exemplary configuration of a projection apparatus according to an arrangement pattern 2 of the embodiment of the present disclosure;

FIG. 15 is a diagram showing still another exemplary configuration of a projection apparatus according to an arrangement pattern 3 of the embodiment of the present disclosure;

FIG. 16 is a diagram showing still another exemplary configuration of a projection apparatus according to an arrangement pattern 4 of the embodiment of the present disclosure;

FIG. 17 is a diagram showing an exemplary installation mode according to an installation mode 1 of the polarization conversion member of the embodiment of the present disclosure;

FIG. 18 is a diagram showing another exemplary installation mode according to an installation mode 2 of the polarization conversion member of the embodiment of the present disclosure;

FIG. 19 is a diagram showing still another exemplary installation mode according to an installation mode 3 of the polarization conversion member of the embodiment of the present disclosure;

FIGS. 20A and 20B are conceptual views each showing projection by a projection apparatus, FIG. 20A showing a concept of projection by a projection apparatus in related art, FIG. 20B showing a concept of projection by the projection apparatus according to the embodiment of the present disclosure;

FIG. 21 is a perspective view showing an exemplary configuration of a projection apparatus according to a modified example of the present disclosure; and

FIG. 22 is a perspective view showing an exemplary configuration of a projection apparatus according to another modified example of the present disclosure.

### DETAILED DESCRIPTION OF EMBODIMENTS

Hereinafter, description will be given on an example of a projection apparatus according to an embodiment of the present disclosure with reference to the drawings in the following order. It should be noted that the present disclosure is not limited to the example to be described later.

1. Schematic Exemplary Configuration of Projection Apparatus

2. Problems to Be Solved by the Present Disclosure

3. Application Example of Projection Apparatus

4. Exemplary Arrangement Pattern of Optical Member of Projection Apparatus

5. Exemplary Installation Mode of Polarization Conversion Section in Projection Apparatus

6. Difference between Related Art and the Present Disclosure

7. Various Modified Examples

### 1. Schematic Exemplary Configuration of Projection Apparatus

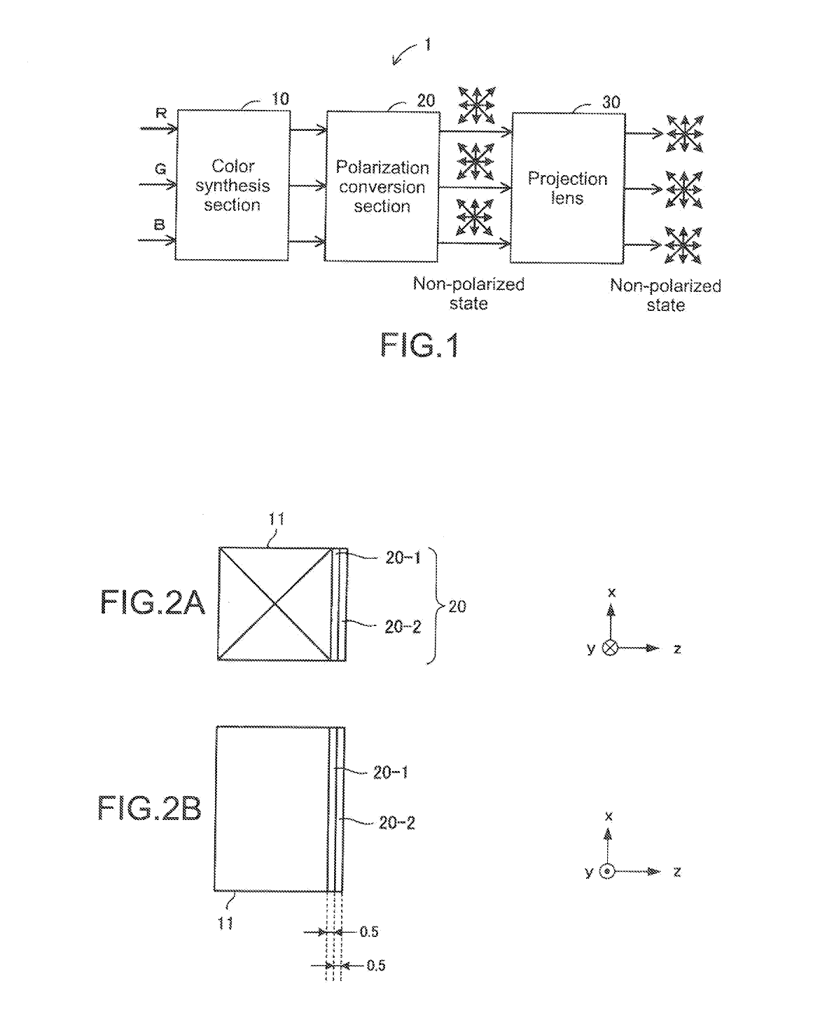

FIG. 1 is a diagram showing a schematic exemplary configuration of a projection apparatus. A projection apparatus (projector) 1 includes a color synthesis section 10, a polarization conversion section 20, and a projection lens 30.

The color synthesis section 10 combines color light in three primary colors of R (Red), G (Green), and B (Blue) and emits the resulting combined light. The polarization conversion section 20 is disposed on the light-emission side of the color synthesis section 10 and converts a polarization state of each color light in the combined light into a non-polarized state that is uniform in all directions. The projection lens 30 emits the light output from the polarization conversion section 20 onto a screen.

As shown in FIGS. 2A and 2B, the polarization conversion section 20 is formed of a first polarization conversion member 20-1 and a second polarization conversion member 20-2, any of which is formed of a uniaxial crystal that is a crystal having one optic axis. FIGS. 2A and 2B are explanatory views each showing a state where the first polarization conversion member 20-1 and the second polarization conversion member 20-2 are mounted to a color synthesis prism 11 that is a constituent element of the color synthesis section 10. FIG. 2A is a side view and FIG. 2B is a top view. In FIGS. 2A and 2B, an axis in which light travels is indicated by a z axis, a horizontal direction is indicated by an x axis, and a vertical direction is indicated by a y axis.

As shown in FIGS. 2A and 2B, the first polarization conversion member 20-1 is disposed on the light-emission side of the color synthesis prism 11, and the second polarization conversion, member 20-2 is disposed on the light-emission side of the first polarization conversion member 20-1. The first polarization conversion member 20-1 and the second polarization conversion member 20-2 have substantially the same length in the horizontal (x) direction and in the vertical (y) direction as the color synthesis prism 11, and have the thickness (length in the z direction) of about 0.5 mm.

The uniaxial crystal has characteristics that a refraction index affects more on incoming light whose oscillation direction is the same as the slow axis of the uniaxial crystal itself, but affects less on incoming light whose oscillation direction is different from that of the slow axis of the uniaxial crystal. Therefore, in the case where incoming polarized light oscillates (rotates) in a direction shifted by an angle of 45° with respect to the slow axis, outgoing polarized, light is in a non-polarized state.

By use of, as the first polarization conversion member 20-1, a member whose slow axis is tilted by an angle of 45° with respect to an oscillation direction of a polarization component of the combined light emitted from the color synthesis prism 11, a polarization state of light output from the first polarization conversion member 20-1 can be set to a non-polarized state. In the case where S-polarized light that vertically oscillates with respect, to an incident surface or P-polarized light that horizontally oscillates with respect to the incident surface is emitted from the color synthesis prism 11, the slow axis of the first polarization, conversion member 20-1 may be set at an angle of 45°, 135°, 225°, or 315°.

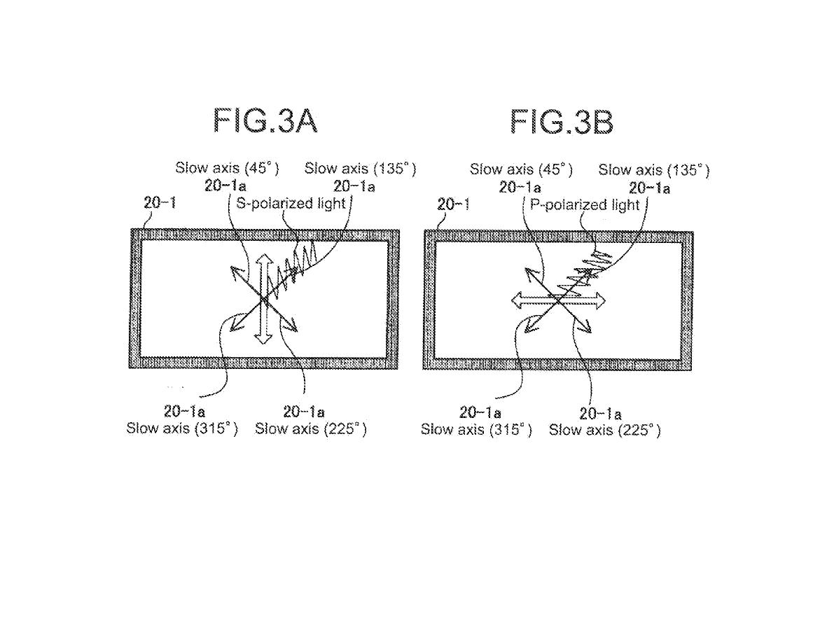

FIG. 3A is a perspective view showing an example of the case where S-polarized light enters the first polarization conversion member 20-1 formed of the uniaxial crystal. FIG. 3B is a perspective view showing an example of the case where P-polarized light enters the first polarization conversion member 20-1. A slow axis 20-1a of the first polarization conversion member 20-1 is set at an angle of 45°, 135°, 225°, or 315° so that the tilt of the slow axis 20-1a can be set to an angle of 45° with respect to both the vertical direction as the oscillation direction of the P-polarized light and the horizontal direction as the oscillation direction of the S-polarized light.

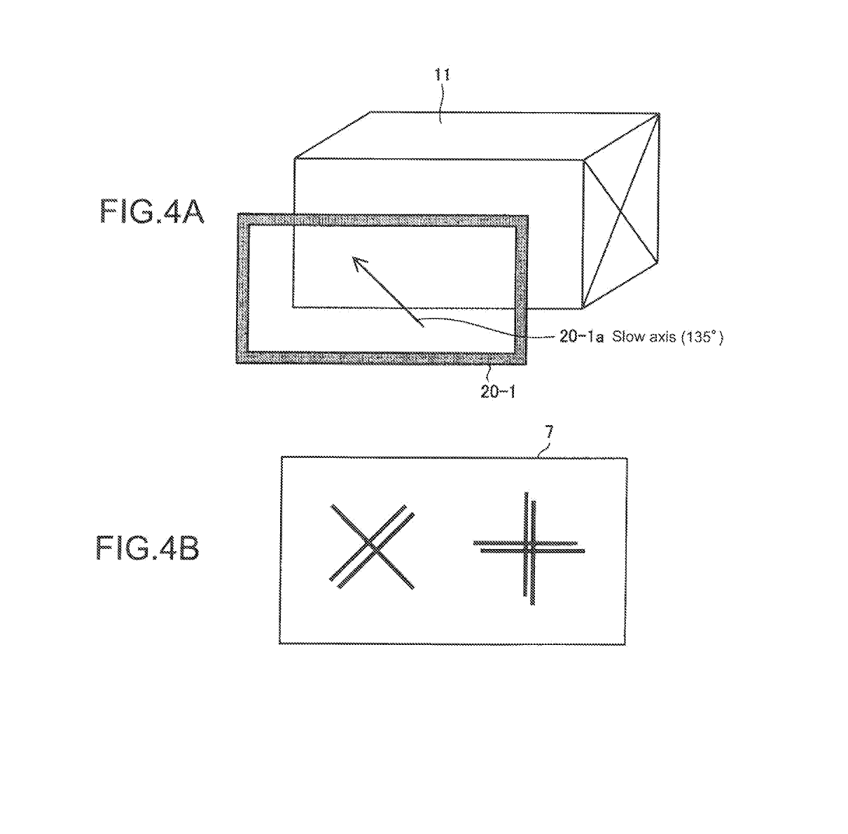

However, when the first polarization conversion member 20-1 formed of the uniaxial crystal is disposed on the light-emission side of the color synthesis prism 11 as described above, light that has passed through the first polarization conversion member 20-1 is separated into an ordinary ray and an extraordinary ray due to double refraction. FIG. 4A is an explanatory view showing an example in which the first polarization conversion member 20-1 having the slow axis 20-1a of 135° is disposed on the light-emission side of the color synthesis prism 11. FIG. 4B is an explanatory view showing a state where light that has passed through the first polarization conversion member 20-1 and has been output from the projection lens 30 (see FIG. 1) is emitted onto the screen 7.

Since the light that has passed through the first polarization, conversion member 20-1 is separated into an ordinary ray and an extraordinary ray, an image to be projected onto the screen 7 is reduplicated as indicated in FIG. 4B by two cross patterns with different tilts. In other words, there arises a problem of a poor resolution. In order to solve this problem, in the projection apparatus 1 according to the embodiment of the present disclosure, another second polarization conversion member 20-2 is superposed on the light-emission side of the first polarization conversion member 20-1 formed of the uniaxial crystal.

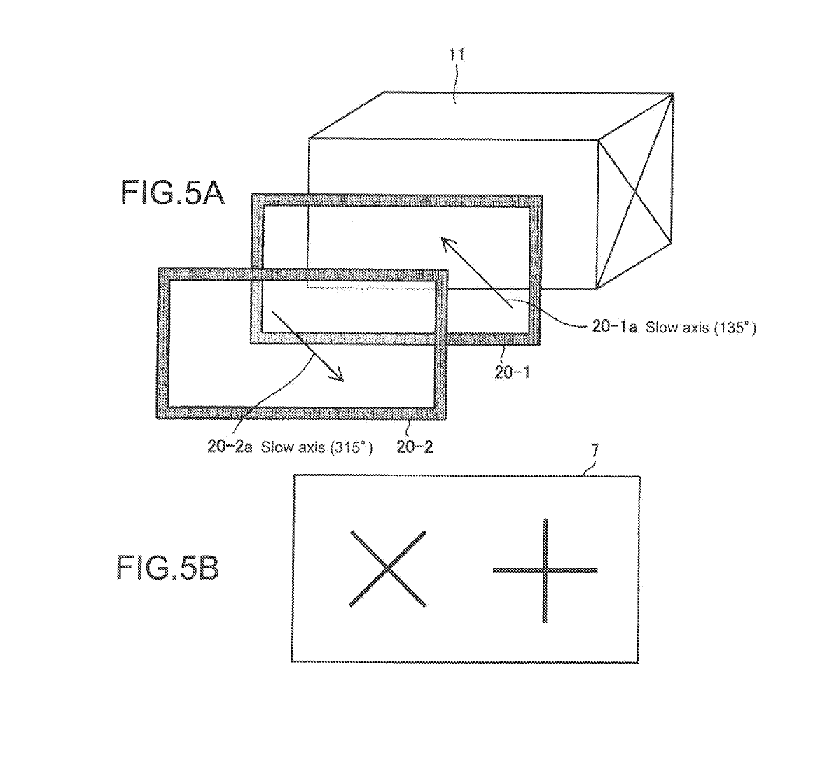

FIG. 5A is a perspective view showing an example in which the first polarization conversion member 20-1 and the second polarization conversion member 20-2 are superposed on each other on the light-emission side of the color synthesis prism 11. The second polarization conversion member 20-2 is also formed of the uniaxial crystal, but a slow axis 20-2a thereof is set to the opposite direction by 180° with respect to the slow axis 20-1a of the first polarization conversion member 20-1. The second polarization conversion member 20-2 is disposed on the light-emission side of the first polarization conversion member 20-1, and therefore the light separated into two of the ordinary ray and the extraordinary ray in the first polarization conversion member 20-1 is integrated into one light again by passing through the second polarization conversion member 20-2. That is, the extraordinary ray is superposed onto the ordinary ray. Thus, an image to be projected onto the screen 7 is clearly seen without reduplication or blur as indicated in FIG. 5B by two cross patterns with different tilts.

Thus, the projection apparatus 1 includes the color synthesis section 10, the polarization conversion section 20, and the projection lens 30. The polarization conversion section 20 is configured to convert a polarization state of each color light emitted from the color synthesis section 10 into a non-polarized state that is uniform in ail directions, without lowering a resolution. Thus, the light radiated from the projection lens 30 onto the screen 7 is put in the non-polarized state and has a high resolution.

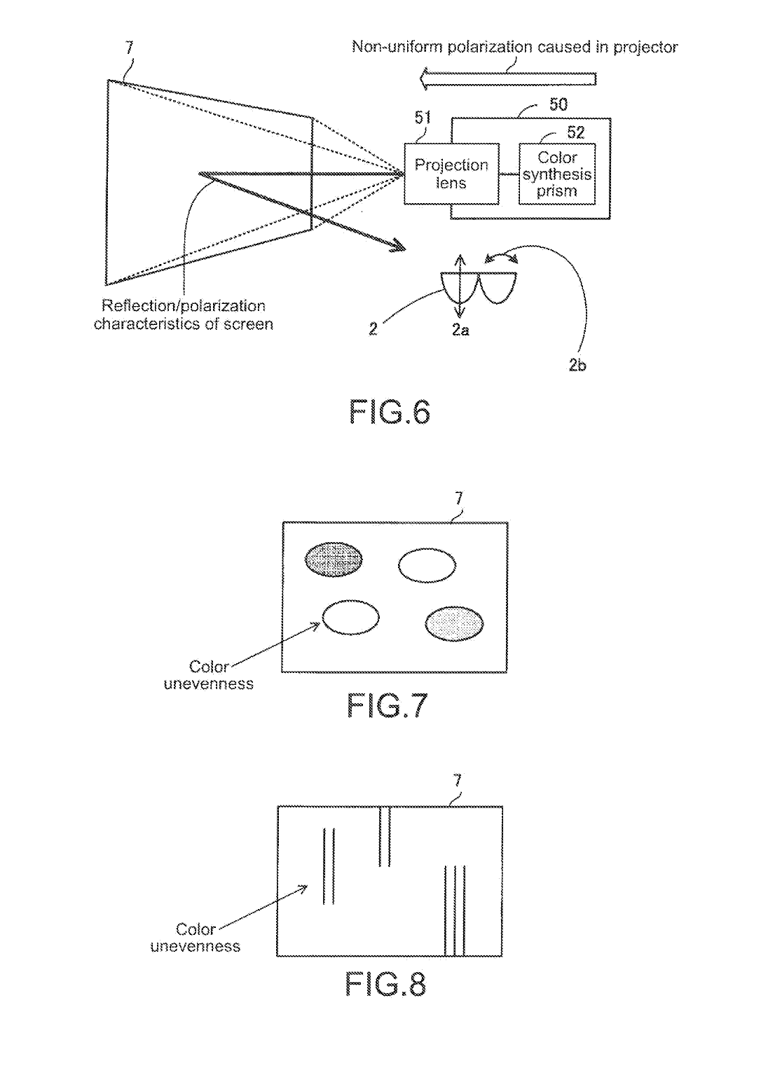

With this configuration, light that is reflected on the screen 7 and then enters the 3D glasses 2 (see FIG. 6) is also in the non-polarized state that is uniform in all directions. Therefore, the color unevenness of 3D images when the 3D glasses 2 are not tilted and the color unevenness and brightness reduction of 3D images when the 3D glasses 2 are tilted can be completely eliminated. Further, even in the case where the projection apparatus 1 is used in the state where an angle of projection largely differs depending on the position of the screen 7, since the light output from the projection apparatus 1 is in the non-polarized state, the color unevenness due to a deviation of reflection of polarized light on the screen 7 disappears. Additionally, the phenomenon that an image to be projected onto the screen 7 is reduplicated or blurred does not occur, and therefore the resolution is kept to be high. In other words, the quality of 2D images and 3D images can be significantly improved.

### 2. Problems to be Solved by the Present Disclosure

Described next in detail are problems to be solved by the present disclosure. FIG. 6 is a diagram showing factors that change the polarization state of light in the case where the embodiment of the present disclosure is applied to a projection apparatus of 3D images. In a projection apparatus (projector) 50, light coming from a projection lens 51 (projection light) is reflected on the screen 7, and then reaches the 3D glasses 2. The polarization state of the light entering the 3D glasses 2 is affected mainly by the following three factors.

### (1) Non-Uniform Polarization Caused in Projector 50

Non-uniform polarization is caused in the projector 50, specifically in the part from a color synthesis prism 52 to the projection lens 51. The non-uniform polarization is caused specifically by the projection lens 51, even if the projection lens 51 is formed of a glass lens or a plastic lens. When the projection lens 51 is a glass lens, the non-uniform polarization is caused due to the material, the shape, the AR (Anti Reflection) coating, and others of the glass lens. When the projection lens 51 is a plastic lens, the non-uniform polarization is caused due to the material, the shape, the AR coating, molding conditions, and others of the plastic lens. Especially in the plastic lens, the level of the non-uniform polarization is more conspicuous. However, an aspherical plastic lens is used as a lens forming the projection lens 51 in many cases because of the inexpensive price thereof. For example, if two or three spherical lenses are substituted with aspherical lenses and a plastic lens is used as the aspherical lens to be substituted, the manufacturing costs of the projection lens 51 can be reduced. Therefore, there are many cases where one aspherical plastic lens or more is used for the projection lens 51.

### (2) Reflection/Polarization Characteristics of Screen 7

When the screen 7 is particularly a silver screen, the non-uniform polarization caused by the above-described factor (1) in the projector 50 directly affects the quality of 3D images. This is because the silver screen has characteristics of reflecting projection light while maintaining the polarization state of the light. Moreover, if the screen has a deviation in polarization characteristics depending on a position within an image of the screen, the polarization state is directly affected by the factor (3) below.

### (3) Tilt Angle of Observer's 3D Glasses 2

As for the 3D glasses 2 under the normal use, a tilt angle 2b thereof with respect to a polarized-light transmission axis 2a is about ±25° when the observer tilts his/her head. When the observer tilts his/her head and the tilt angle 2b of the 3D glasses 2 reaches about ±25°, a polarized-light transmission direction of the 3D glasses 2 is also changed. As a result, the quality of the 3D images is also greatly changed.

Due to the polarization-state-changing factors (1) to (3) above, the polarization state of the light entering the 3D glasses 2 is changed. Thus, two main events as below have occurred previously.

(a) In 3D images, color unevenness is perceivable when the 3D glasses 2 are not tilted.

(b) In 3D images, color unevenness and brightness reduction are perceivable when the 3D glasses 2 are tilted.

FIGS. 7 and 8 are diagrams each showing color unevenness to be perceived via the 3D glasses 2. For example, when a video whose background is white in color is projected onto the screen 7, color unevenness as shown in FIG. 7 (indicated by elliptical figures) may be observed in places of the screen 7. Further, for example, when a screen having a deviation in polarization characteristics depending on a position within the screen is used as the screen 7, and when the observer tilts his/her head and the tilt angle 2b of the 3D glasses 2 (see FIG. 6) reaches an angle larger than a predetermined angle, the observer may perceive linear color unevenness as shown in FIG. 8 within an image on the screen 7.

In order to solve the previous problems (a) and (b), the polarization-state-changing factor (1) is expected to be used, for a solution. This is because it is difficult for an observer (customer) to change the polarization-state-changing factor (2). For example, normally the observer is not allowed to specify the screen 7 to be placed, and therefore the observer is not allowed to improve the quality of 3D images by changing the reflection/polarization characteristics of the screen 7. The polarization-state-changing factor (3) is assumed to be solved using, as the 3D glasses 2, dedicated 3D glasses and the like that are insusceptible to the influence of the tilt angle 2b. However, providing the dedicated 3D glasses is not practical considering the recent trend toward the standardization of the 3D glasses 2. That is, it is also difficult to solve the previous problems (a) and (b) by using the polarization-state-changing factor (3) for a solution.

In solving the previous problems (a) and (b) by using the polarization-state-changing factor (1), the problem (a) can be solved by the following approaches (#1) to (#3).

(#1) Use the projection lens 51 that is a lens entirely made of glass, i.e., avoid use of a plastic lens. However, this solves the problem (a) but not the problem (b).

(#2) When the color synthesis prism 52 is of an SPS model, a wavelength-selective half-wave plate (Color Select) is provided between the projection lens 51 and the color synthesis prism 52. Using the wavelength-selective half-wave plate, S-polarized light/P-polarized light/S-polarized light is aligned to have P-polarized light/P-polarized light/P-polarized light or S-polarized light/S-polarized light/S-polarized light in order of RGB. However, this solves the problem (a) but not the problem (b).

It should be noted that as for a color synthesis prism generally used in a projection apparatus, an SPS model is more popular than an SSS model because green light is higher in transmittance when being P-polarized than when being S-polarized. However, the SSS model is also used for polarization alignment of RGB light after the light is emitted from the color synthesis prism.

(#3) Use the color synthesis prism 52 of an SSS model. However, this solves the problem (a) but not the problem (b). Moreover, the transmittance of G (Green) is considerably reduced, which greatly reduces the 2D brightness.

Thus, to solve the problem (a), the approaches (#1) to (#3) described above are available. However, those approaches (#1) to (#3) do not solve the problem (b). This is because the approaches (#1) to (#3) merely allow the RGB light to be linearly polarized in the same direction, and do not allow the projection light of the projector 50 to be converted to have a non-polarized state.

To solve both the problems (a) and (b), a possible approach is to change the polarization state into the non-polarized state by providing any of the wavelength-selective half-wave plate, a uniaxial organic material, and the uniaxial crystal on the light-emission side of the projection lens 51, i.e., on the light-emission stage thereof. This configuration leads to satisfactory results for both the problems (a) and (b) described above.

However, this configuration does not always make 3D images completely free of color unevenness and brightness reduction. This is because, when the polarization patterns of light are affected too much, especially when the projection lens is a plastic lens, for example, the light is not sufficiently put in the non-polarization state. In this case, the resulting 3D images undergo slight color unevenness/brightness reduction.

If any of the wavelength-selective half-wave plate, the uniaxial organic material, and the uniaxial crystal is disposed on the light-emission side of the projection lens 51, the projection light from the projection lens 51 can be set to have a state close to the non-polarized state. However, when the projection lens 51 in use is a plastic lens that greatly affects the polarization patterns of the light, the projection light can have a state close to the non-polarized state, but it is difficult to put the light in the non-polarized state that is uniform in all directions, thus resulting in deviated non-polarized state. For these reasons, the 3D images are not completely free of color unevenness and brightness reduction even with the above configuration. There may be another approach to increase the thickness of the uniaxial organic material or the uniaxial crystal. This approach, however, causes a problem of impairing the focusing capability.

Those problems described above are solved by a method of disposing the polarization conversion section formed of the uniaxial crystal, the uniaxial organic material, the wavelength-selective half-wave plate, or the like between the color synthesis section and the projection lens or on the light-emission side of the projection lens. By passage of combined light through such a polarization conversion section, the polarization state of each color light in the combined light generated in the color synthesis section is converted into the non-polarized state that is uniform in all directions. Thus, the light observed through the 3D glasses as well as the light at various angles of projection coming from a short focus projector are put in the non-polarized state. Therefore, the color unevenness of 3D images when the 3D glasses are not tilted, the color unevenness and brightness reduction of 3D images when the 3D glasses are tilted, and the color unevenness of 2D images that is found in an image projected from a short focus projector are not found any more. Similarly, the color unevenness caused by using a non-diffusive screen and a short focus projector used in a state where the angle of projection becomes large can also be eliminated.

However, with such a configuration, there occurs a phenomenon that an image projected onto a screen is blurred or reduplicated, thus resulting in reduction of the resolution.

The present disclosure has been made in view of such points, and it is desirable to eliminate the color unevenness and brightness reduction of 3D images and the color unevenness of 2D images without lowering a resolution.

### 3. Application Example of Projection Apparatus

Described next will be a transmissive LCD projector and a reflective LCD projector as application examples of the projection apparatus 1.

### 3-1. Application Example to Transmissive LCD Projector

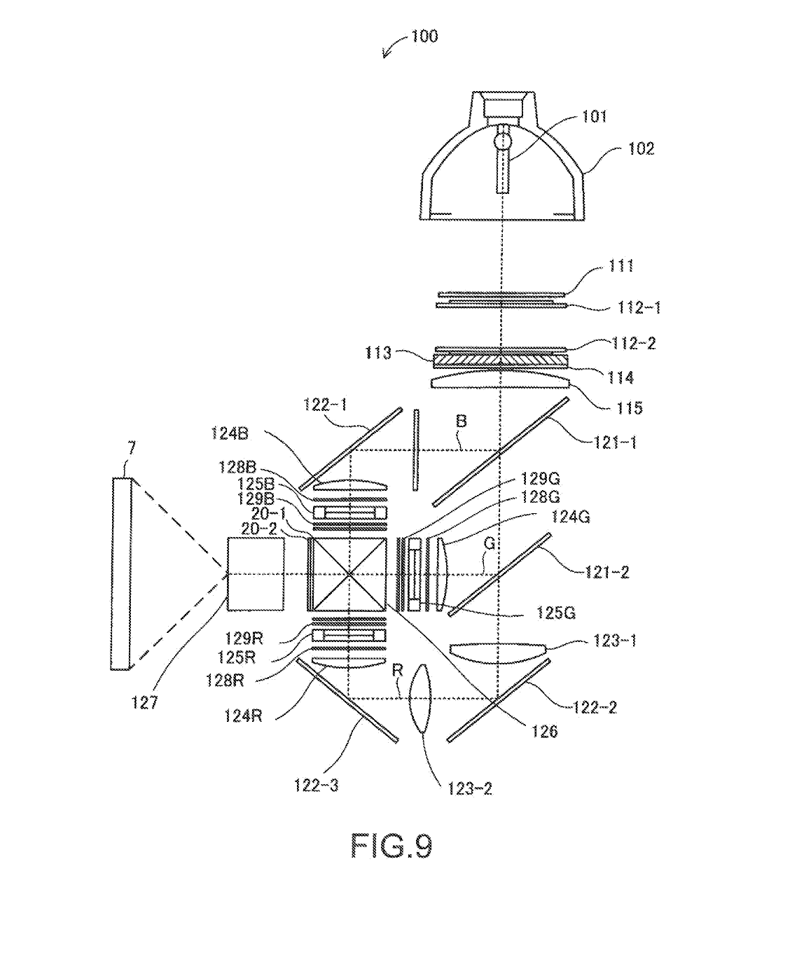

FIG. 9 is a diagram showing an exemplary configuration of an optical unit of a transmissive LCD projector. A transmissive LCD projector 100 includes a light source section, an illumination optical system, a separation optical system, a light modulation element section, a synthesis optical system, and a projection optical system.

The light source section includes a light source 101 and a reflector 102. The light source 101 is exemplified by an HID (High Intensity Discharge) lamp including an extra-high-pressure mercury lamp and a metal-halide lamp, for example. The light source 101 emits white light. The light source 101 is disposed at a focal position of the reflector 102 and generates substantially-parallel light by reflecting the white light coming from the light source 101 on the reflector 102. The reflector 102 is not restrictive to be in the parabolic shape and may be in the elliptical shape, for example.

The illumination optical system includes a UV (Ultra Violet) cut filter 111, fly-eye lenses 112-1 and 112-2, a polarized-light separation element 113, a wave plate unit (polarized-light modulation element) 114, and a condenser lens 115.

The UV cut filter 111 is provided in front of the light source 101 to block passage of ultraviolet rays coming from the light source 101. The fly-eye lenses 112-1 and 112-2 receive the substantially-parallel light after reflection on the reflector 102 and emit the substantially-parallel light to the polarized-light separation element 113. The fly-eye lenses 112-1 and 112-2 make the illuminance of the light entering the light modulation element section uniform.

The polarized-light separation element 113 receives light containing S- and P-polarized light and separates the light into the S-polarized light and the P-polarized light, to output the separated S-polarized light and P-polarized light to different regions.

The wave plate unit 114 aligns a polarization axis of the light output from the polarized-light separation element 113 along a predetermined direction. For example, the wave plate unit 114 modulates the P-polarized light, which has entered a first region, to be the S-polarized light and aligns the polarization axis thereof along the S-polarized light that has entered a second region.

The condenser lens 115 receives and gathers the light output from the wave plate unit 114. The white light emitted from the condenser lens 115 enters the separation optical system.

The separation optical system separates the light coming from the condenser lens 115 into RGB (Red, Green, and Blue) light. The separation optical system includes dichroic mirrors 121-1 and 121-2, reflection mirrors 122-1 to 122-3, relay lenses 123-1 and 123-2, and condenser lenses 124R, 124G, and 124B.

The dichroic mirrors 121-1 and 121-2 selectively transmit or reflect each of the RGB light based on the wavelength ranges thereof. The dichroic mirror 121-1 transmits the light G and R in the green and red wavelength ranges, respectively, and reflects the light B in the blue wavelength range.

The dichroic mirror 121-2 transmits the light R in the red wavelength range and reflects the light G in the green wavelength range. Thus, the white light is separated into light in three colors of RGB. It should be noted that those dichroic mirrors are used for any of red light separation and blue light separation.

The reflection mirror 122-1 is formed of a total reflection mirror and configured to reflect the light B in the blue wavelength range after separation by the dichroic mirror 121-1 to guide the light B to a light modulation element 125B. Each of the reflection mirrors 122-2 and 122-3 is also formed of a total reflection mirror and configured to reflect the light R in the red wavelength range after separation by the dichroic mirror 121-2 and to guide the light R to a light modulation element 125R.

The relay lenses 123-1 and 123-2 correct an optical path length for the light R in the red wavelength range. The condenser lenses 124R, 124G, and 124B converge the light R, G, and B in the red, green, and blue wavelength ranges, respectively.

The light coming from such a separation optical system, i.e., the light R, G, and B in the red, green, and blue wavelength ranges, enter the light modulation elements 125R, 125G, and 125B, respectively.

In front of the light modulation elements 125R, 125G, and 125B, i.e., on the light source side, incident-side polarization plates 128R, 128G, and 128B are respectively provided. Those incident-side polarization plates 128R, 128G, and 128B respectively align polarization components of the light R, G, and B in the red, green, and blue wavelength ranges that are emitted from the separation optical system.

The light modulation elements 125R, 125G, and 125B performs spatial modulation on the light R, G, and B in the red, green, and blue wavelength ranges, respectively. Emission-side polarization plates 129R, 129G, and 129B each transmit a predetermined polarization component (for example, S-polarized light or P-polarized light) of the spatially-modulated light.

The synthesis optical system includes a color synthesis prism 126. The color synthesis prism 126 transmits the light G in the green wavelength range and reflects the light R and B in the red and blue wavelength ranges, respectively, toward the projection optical system.

The color synthesis prism 126 is a joined prism formed of a plurality of glass prisms, i.e., four isosceles right prisms having substantially the same shape, for example. On the surfaces where the glass prisms are combined together, two interference filters having predetermined optical characteristics are formed.

A first interference filter reflects the light B in the blue wavelength range and transmits the light R and G in the red and green wavelength ranges, respectively. A second interference filter reflects the light R in the red wavelength range and transmits the light G and B in the green and blue wavelength ranges, respectively. Thus, after modulation by the light modulation elements 125R, 125G, and 125B, the resulting RGB light is combined together in the color synthesis prism 126.

The first polarization conversion member 20-1 formed of the uniaxial crystal is disposed on the light-emission side of the color synthesis prism 126, and the second polarization conversion member 20-2 similarly formed of the uniaxial crystal is disposed on the light-emission side of the first polarization conversion member 20-1. The slow axis 20-1a (see FIG. 3) of the first polarization conversion member 20-1 is set to any angle of 45°, 135°, 225°, and 315°. In the second polarization conversion member 20-2, the slow axis 20-2a thereof is set to the opposite direction by 180° with respect to the slow axis 20-1a of the first polarization conversion member 20-1. In other words, in the case where the slow axis 20-1a of the first polarization conversion member 20-1 has an angle of 45°, for example, the slow axis 20-2a of the second polarization conversion member 20-2 is set to an angle of 225°. In the case where the slow axis 20-1a of the first polarization conversion member 20-1 has an angle of 135°, for example, the slow axis 20-2a of the second polarization conversion member 20-2 is set to an angle of 315°.

A projection lens 127 serving as the projection optical system magnifies the light, which is emitted from the color synthesis prism 126 and passes through the first polarization conversion member 20-1 and the second polarization conversion member 20-2, to a predetermined magnification for video projection on the screen 7.

### 3-2. Application Example to Reflective LCD Projector

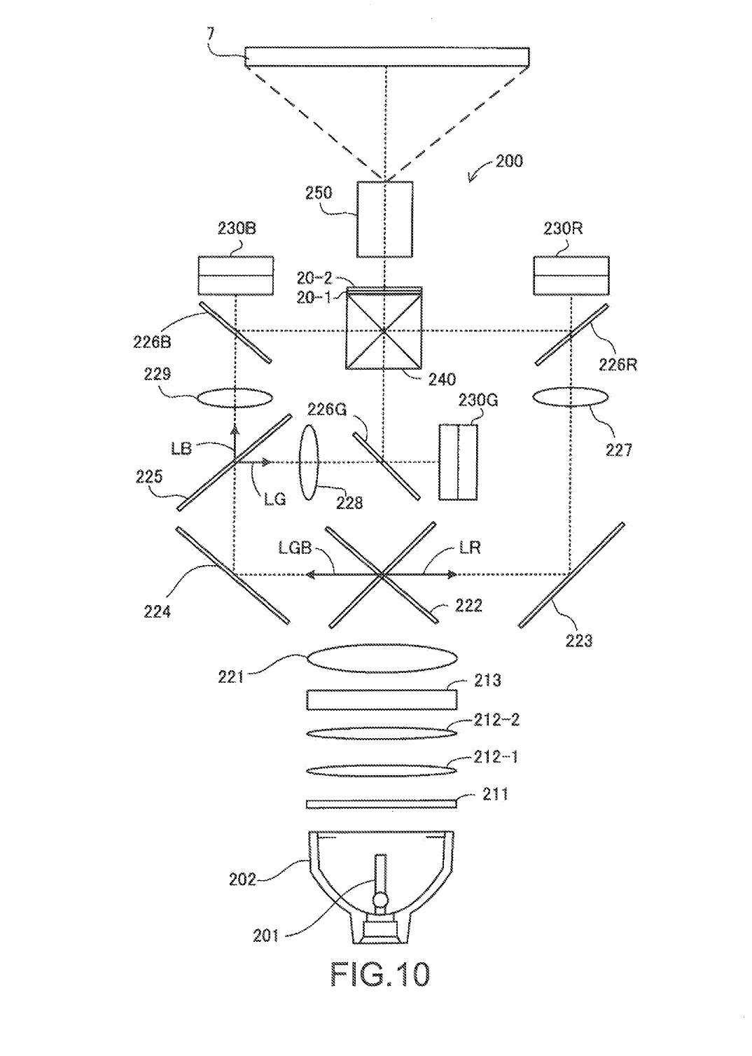

FIG. 10 is a diagram showing an exemplary configuration of an optical unit of a reflective LCD projector. In a reflective LCD projector 200, a light source 201 is disposed at a focal position of a reflector 202 and generates substantially-parallel light by reflecting white light coming from the light source 201 on the reflector 202.

A UV/IR (Ultra Violet/Infrared Rays) cut filter 211 receives the substantially-parallel light and blocks passage of ultraviolet rays and infrared rays. Herein, the reflector 202 is not restrictive to be in the parabolic shape and may be in the elliptical shape, for example.

Fly-eye lenses 212-1 and 212-2 make the illuminance of light uniform, and a PS converter (polarization conversion element) 213 aligns the randomly polarized light, i.e., P-polarized light/S-polarized light, along one polarization direction. A main condenser lens 221 gathers the white illumination light whose polarization direction is uniformly aligned by the PS converter 213.

A dichroic mirror 222 separates the white illumination light into red light LR in the red wavelength range and green and blue light LGB in the green and blue wavelength ranges. It should be noted that the dichroic mirror 222 is also used for any of red light separation and blue light separation. A reflection mirror 223 reflects the red light LR after separation by the dichroic mirror 222.

A reflection mirror 224 reflects the green and blue light LGB after separation by the dichroic mirror 222. A dichroic mirror 225 reflects only the light in the green wavelength range out of the light LGB after reflection by the reflection mirror 224 and transmits the remaining light in the blue wavelength range.

A polarization plate 226R transmits the red light LR serving as P-polarized light, which is reflected on the reflection mirror 223, and then causes the red light LR to enter a reflective liquid crystal panel 230R. The reflective liquid crystal panel 230R then performs spatial modulation on the red light LR and causes the resulting S-polarized red light to enter a color synthesis prism 240 by reflection. It should be noted that the color synthesis prism 240 may be provided with a polarization plate on each surface where the RGB light enters.

A polarization plate 226G transmits the green light LG serving as P-polarized light, which is reflected on the dichroic mirror 225, and then causes the green light LG to enter a reflective liquid crystal panel 230G. The reflective liquid crystal panel 230G then performs spatial modulation on the green light LG and causes the resulting S-polarized green light to enter the color synthesis prism 240 by reflection.

Further, when the color synthesis prism 240 is of an SSS model, the green light enters the color synthesis prism 240 as it is. When the color synthesis prism 240 is of an SPS model, a half-wave plate is disposed on the light-incident side thereof, and the green light is P-polarized and enters the color synthesis prism 240.

A polarization plate 226B transmits the blue light LB serving as P-polarized light, which passes through the dichroic mirror 225, and then causes the blue light LB to enter a reflective liquid crystal panel 230B. The reflective liquid crystal panel 230B then performs spatial modulation on the blue light LB and causes the resulting S-polarized blue light to enter the color synthesis prism 240 by reflection.

It should be noted that optical lenses 227, 228, and 229 are provided on the light-incident side of the polarization plates 226R, 226G, and 226B, respectively (a polarization plate may also be disposed between the optical lens 228 and the polarization plate 226R, 226G, or 226B).

Here, the white light coming from the light source 201 is made uniform in illuminance by the fly-eye lenses 212-1 and 212-2 and is aligned by the PS converter 213 to have a predetermined polarization direction. The output light is then oriented by the main condenser lens 221 to illuminate the reflective liquid crystal panels 230R, 230G, and 230B, and thereafter the light is then separated into light in three different wavelength ranges by the dichroic mirrors 222 and 225 and the like each serving as a color serration mirror.

After the separation, the resulting color light enters a reflective polarization plate, and only light in one specific polarization direction is selected by the polarization plates 226R, 226G, and 226B to enter the reflective liquid crystal panels 230R, 230G, and 230B. Thus, the RGB light serving as the P-polarized light enters the reflective liquid crystal panels 230R, 230G, and 230B.

The reflective liquid crystal panels 230R, 230G, and 230B are each applied with a video signal corresponding to the color of incoming light. According to the video signals, the reflective liquid, crystal panels 230R, 230G, and 230B rotate the incoming light to change the polarization direction thereof. The resulting light is then modulated and output. The modulated light coming from those liquid crystal panels enters again the polarization plates 226R, 226G, and 226B.

Prom the polarized light that have entered the polarization plates 226R, 226G, and 226B, only any 90-degree rotated polarized components are selected and then enter the color synthesis prism 240. In the color synthesis prism 240, each color light after modulation by the three reflective liquid crystal panels is combined together along the same direction and then emitted. The first polarization conversion member 20-1 formed of the uniaxial crystal is disposed on the light-emission side of the color synthesis prism 240, and the second polarization conversion, member 20-2 similarly formed of the uniaxial crystal is disposed on the light-emission side of the first polarization conversion member 20-1. The slow axis 20-1a (see FIG. 3) of the first polarization conversion member 20-1 is set to any angle of 45°, 135°, 225°, and 315°. The slow axis 20-1a of the first polarization conversion member 20-1 and the slow axis 20-2a of the second polarization conversion member 20-2 are set to be opposite to each other by 180°. The combined light emitted from the color synthesis prism 240 passes through the first polarization conversion member 20-1 and the second polarization conversion member 20-2 and thereafter is output for projection by the projection lens 250 onto the screen 7.

Described next will be the polarization conversion section 20 In the projection apparatus 1. A uniaxial crystal is used for the polarization conversion section 20. The uniaxial crystal is a crystal having one optic axis and is exemplified by quartz crystal (quarts), sapphire, calcite, and magnesium fluoride. A phase difference of the uniaxial crystal to be imparted to incoming light is about 10,000 nm (about 1 mm in the case of quartz).

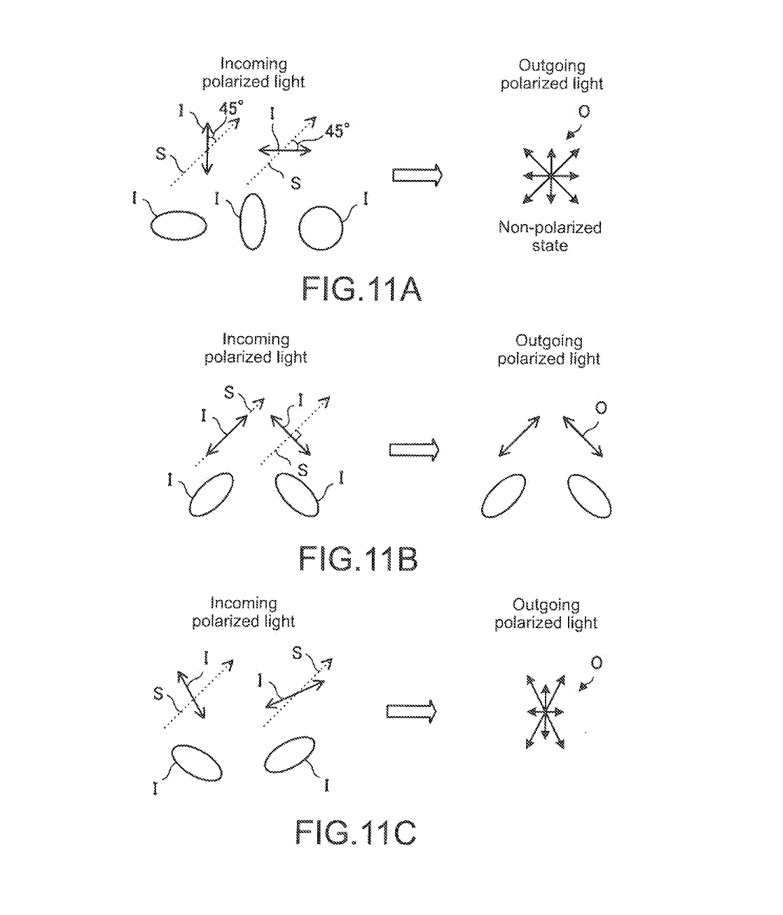

FIGS. 11A, 11B, and 11C are diagrams for describing the characteristics of a uniaxial crystal. FIG. 11A shows an example in which a phase of polarized light that enters the uniaxial crystal is shifted by 45° with respect to the slow axis of the uniaxial crystal. FIG. 11B shows an example in which the phase of the polarized light that enters the uniaxial crystal is shifted by 0° or 90° with respect to the slow axis of the uniaxial crystal. FIG. 11C shows an example in which the phase of polarized light that enters the uniaxial crystal does not correspond to any of 0°, 45°, and 90° with respect to the slow axis of the uniaxial crystal.

The uniaxial crystal has characteristics that a refraction index affects more on incoming light whose oscillation direction is the same as the slow axis of the uniaxial crystal, but affects less on incoming light whose oscillation direction is different from that of the slow axis of the uniaxial crystal. Therefore, as shown in FIG. 11A, in the case where incoming polarized light I oscillates (rotates) in a direction shifted by an angle of 45° with respect to a slow axis S indicated by a broken line, outgoing polarized light O is in a non-polarized state. Further, as shown in FIG. 11B, in the case where the incoming polarized light I oscillates in a direction shifted by 0° or 30° with respect to the slow axis S, outgoing polarized light has the same phase as the incoming polarized light and does not change. On the other hand, as shown in FIG. 11C, in the case where the incoming polarized light I oscillates in a direction other than the above directions with respect to the slow axis S, outgoing polarized light having a large deviation is emitted, and thus the state thereof is not even close to the non-polarized state.

Specifically, by passage of the polarized light whose oscillation direction is shifted by an angle of 45° with respect to the slow axis S of the uniaxial crystal through the uniaxial crystal, each color light of the combined light emitted from the color synthesis section 10 is converted into different polarized light for each wavelength by the uniaxial crystal to be put in the non-polarized state.

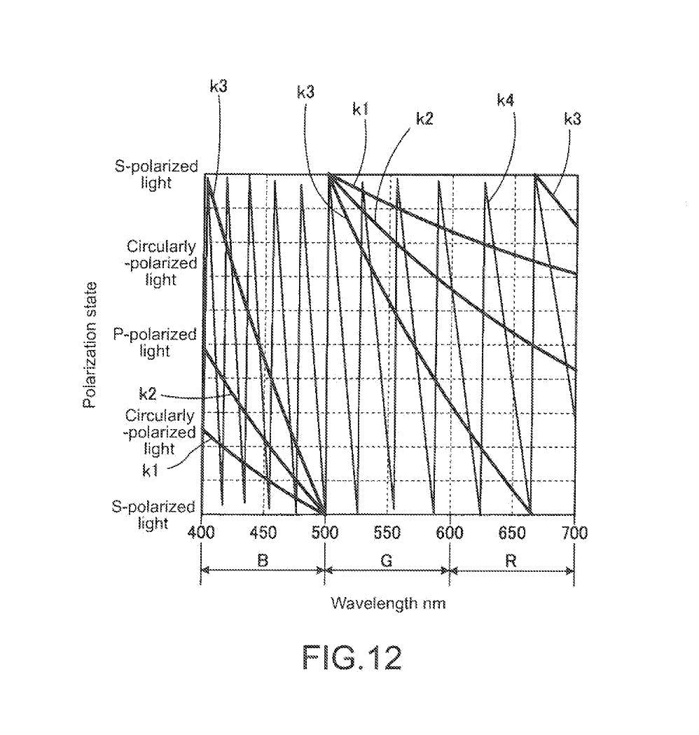

Described next will be the polarization state by a phase difference of the uniaxial crystal. FIG. 12 is a diagram showing a polarization state by a phase difference (retardation) of the uniaxial crystal. The vertical axis indicates the polarization state of polarized light, and the horizontal axis indicates a wavelength (nm) of polarized light. In FIG. 12, a curve k1 has a phase difference of 500 nm, a curve k2 has a phase difference of 1,000 nm, a curve k3 has a phase difference of 2,000 nm, and a curve k4 (sawtooth curve) has a phase difference of 10,000 nm.

Exemplified herein is a case where the phase difference is large, e.g., 10,000 nm, with the slow axis of 45° with respect to incoming linearly-polarized light, which corresponds to the jagged line in the figure. Assuming that linearly-polarized light with a certain wavelength, e.g., 550 nm, passes through the slow axis, light with an adjacent wavelength, e.g., 501 nm, is polarized elliptically (almost linearly).

Thus, combining the light polarized differently in the wavelength range in use (about 430 to 700 nm) produces light polarized differently on a wavelength basis so that the non-polarized state is created.

Therefore, when the polarization conversion section 20 in use is formed of the uniaxial crystal, if the conditions are satisfied, i.e., the slow axis is at an angle of 45° and the phase, difference is large, the light is largely polarized with a change of wavelength so that the light becomes more uniform in the resulting non-polarized state.

Moreover, when the polarized light is linearly-polarized/elliptically-polarized/circularly-polarized light in the S and P directions, the uniaxial crystal serves especially useful because it creates “light polarized differently on a wavelength basis” irrespective of the type of the light. In addition, in the light-incident stage of the uniaxial crystal, the polarization direction (rotation direction) of the light is not expected to be aligned in advance.

### 4. Exemplary Arrangement Pattern of Optical Member

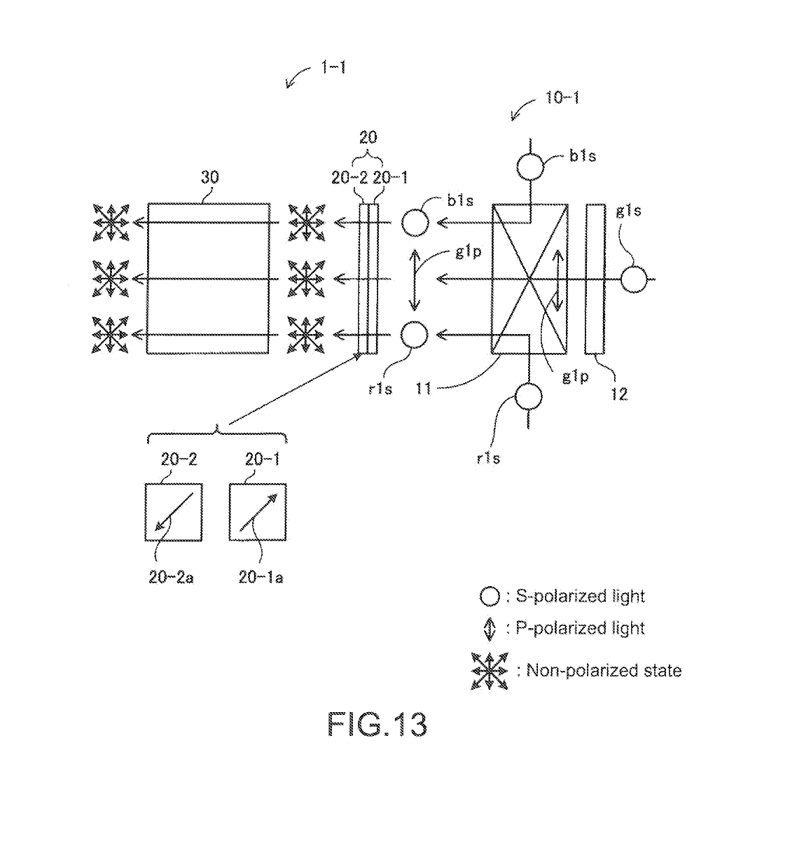

Described next will be an exemplary arrangement pattern of an optical member for polarization conversion processing in the projection apparatus 1 with reference to FIGS. 13 to 17.

### 4-1. Arrangement Pattern 1

FIG. 13 is a diagram showing an exemplary configuration of a projection apparatus according to an arrangement pattern 1. A projection apparatus 1-1 includes a color synthesis section 10-1, the polarization conversion section 20, and the projection lens 30.

The color synthesis section 10-1 includes a color synthesis prism 11 of an SPS model and a half-wave plate 12. The polarization conversion section 20 is formed of the first polarization conversion member 20-1 and the second polarization conversion member 20-2. As described above, the first polarization conversion member 20-1 and the second polarization conversion member 20-2 are each formed of a uniaxial crystal, and the slow axes 20-1a and 20-2a of the first polarization conversion member 20-1 and the second polarization conversion member 20-2 have a tilt of 45° with respect to an amplitude direction of polarized light emitted from the color synthesis prism 11. Further, the slow axis 20-1a of the first polarization conversion member 20-1 and the slow axis 20-2a of the second polarization conversion member 20-2 are set to be opposite to each other by 180°. FIG. 13 exemplifies a case where the slow axis 20-1a of the first polarization conversion member 20-1 has an angle of 45°, and the slow axis 20-2a of the second polarization conversion member 20-2 has an angle of 225°.

The half-wave plate 12 is disposed on a light-incident side of the color synthesis prism 11 where green light enters. The half-wave plate 12 performs polarization conversion on S-polarized green light g1s so that green P-polarized light g1p is generated. It should be noted that the half-wave plate generally has basic functions to produce an optical path difference of a half wavelength (phase difference δ=180°+N×360°) between two linear polarized light (transverse and vertical components) when light passes therethrough. The half-wave plate 12 is used mainly for rotating the plane of polarization at a predetermined angle (N=1, 2, 3, . . . ).

The color synthesis prism 11 generates combined light by combining red S-polarized light r1s, the green P-polarized light g1p, and blue S-polarized light b1s. The red S-polarized light r1s is S-polarized red light, and the blue S-polarized light b1s is S-polarized blue light.

The first polarization conversion member 20-1 of the polarization conversion section 20 converts the polarization states of the light emitted from the color synthesis prism 11, i.e., the red S-polarized light r1s, the green P-polarized light, g1p, and the blue S-polarized light b1s, into the non-polarized states that are uniform in all directions. The second polarization conversion member 20-2 integrates the light separated by passing through the first polarization conversion member 20-1 into one light again.

The projection lens 30 receives the combined light emitted from the polarization conversion section 20, each color light of the combined light being in the non-polarized state. Then, the projection lens 30 magnifies the combined light to a predetermined magnification for emission. After that, the projection light in the non-polarized state that is uniform in all directions is emitted onto the screen.

With the projection apparatus 1-1 configured as described above, the light entering the screen 7 and the light reflected, thereon are each in the non-polarized state that is uniform in all directions. Therefore, the color unevenness of 3D images when the 3D glasses are not tilted and the color unevenness and brightness reduction of 3D images when the 3D glasses are tilted can be completely eliminated. Similarly, the color unevenness caused by using a short focus projector and a non-diffusive screen can also be eliminated.

### 4-2. Arrangement Pattern 2

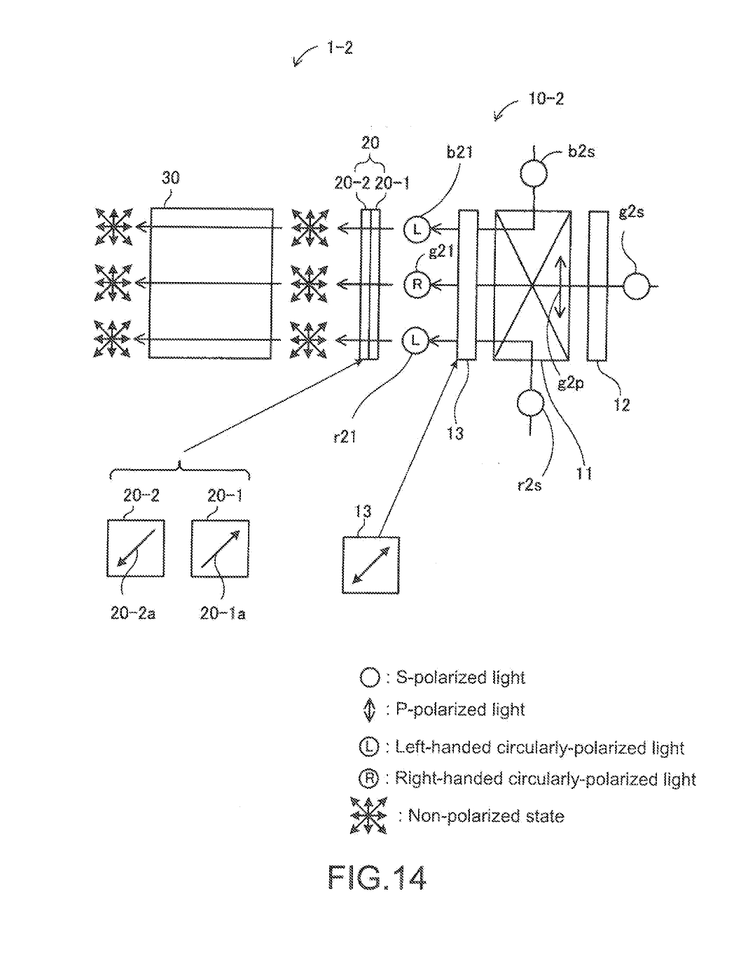

FIG. 14 is a diagram showing an exemplary configuration of a projection apparatus according to an arrangement pattern 2. A projection apparatus 1-2 includes a color synthesis section 10-2, the polarization conversion section 20, and the projection lens 30.

The color synthesis section 10-2 includes a color synthesis prism 11 of an SPS model, a half-wave plate 12, and a quarter-wave plate 13. The configuration of the polarization conversion section 20 is the same as that described above, and therefore overlapping description will be omitted.

The half-wave plate 12 is disposed on a light-incident side of the color synthesis prism 11 where green light enters. The half-wave plate 12 performs polarization conversion on S-polarized green light g2s so that green P-polarized light g2p is generated. The color synthesis prism 11 generates combined light by combining red S-polarized light r2s, the green P-polarized light g2p, and blue S-polarized light b2s. The red S-polarized light r2s is S-polarized red light, and the blue S-polarized light b2s is S-polarized blue light.

The quarter-wave plate 13 is disposed on a light-emission side of the color synthesis prism 11 and is so oriented that the optical axis forms an angle of 45° with respect to the incoming polarized light. Then, the quarter-wave plate 13 converts the red S-polarized light r2s into left-handed circularly-polarized light, i.e., red left-handed circularly-polarized light r21, the green P-polarized light g2p into right-handed circularly-polarized light, i.e., green right-handed circularly-polarized light g21, and the blue S-polarized light b2s into left-handed circularly-polarized light, i.e., blue left-handed circularly-polarized light b21.

It should be noted that the quarter-wave plate 13 generally has basic functions to produce an optical path difference of a quarter wavelength (phase difference δ=90°+N×360°) between two linear polarized light (transverse and vertical components) when light passes therethrough. The quarter-wave plate 13 is often used mainly for converting linearly-polarized light into circularly-polarized light, or conversely, converting circularly-polarized light into linearly-polarized light (N=1, 2, 3, . . . ).

The concern here is that, when light output from the color synthesis prism 11 enters the projection lens 30, the light reflected on the projection lens 30 may return back to the color synthesis prism 11. If this is the case, this may generate stray light and may cause a ghost phenomenon or the like on the screen.

Therefore, in the description above, the quarter-wave plate 13 as described above is provided for prevention of stray light between the light-emission stage of the color synthesis prism 11 and the light-incident stage of the polarization conversion section 20.

On the other hand, the first polarization conversion member 20-1 of the polarization conversion section 20 converts the polarization states of the light emitted from the quarter-wave plate 13, i.e., the red left-hand circularly-polarized light r21, the green right-handed circularly-polarized light g21, and the blue left-handed circularly-polarized light b21, into the non-polarized states that are uniform in all directions. The second polarization conversion member 20-2 integrates the light separated by passing through the first polarization conversion member 20-1 into one light again.

The projection lens 30 receives the combined light emitted from the polarization conversion section 20, each color light of the combined light being in the non-polarized state. Then, the projection lens 30 magnifies the combined light to a predetermined magnification for emission. After that, the projection light in the non-polarized state that is uniform in all directions is emitted onto the screen.

With the projection apparatus 1-2 configured as described above, the same effects as those produced by using the projection apparatus 1-1 can be obtained. In addition, the effect of suppressing generation of stray light can also be obtained.

### 4-3. Arrangement Pattern 3

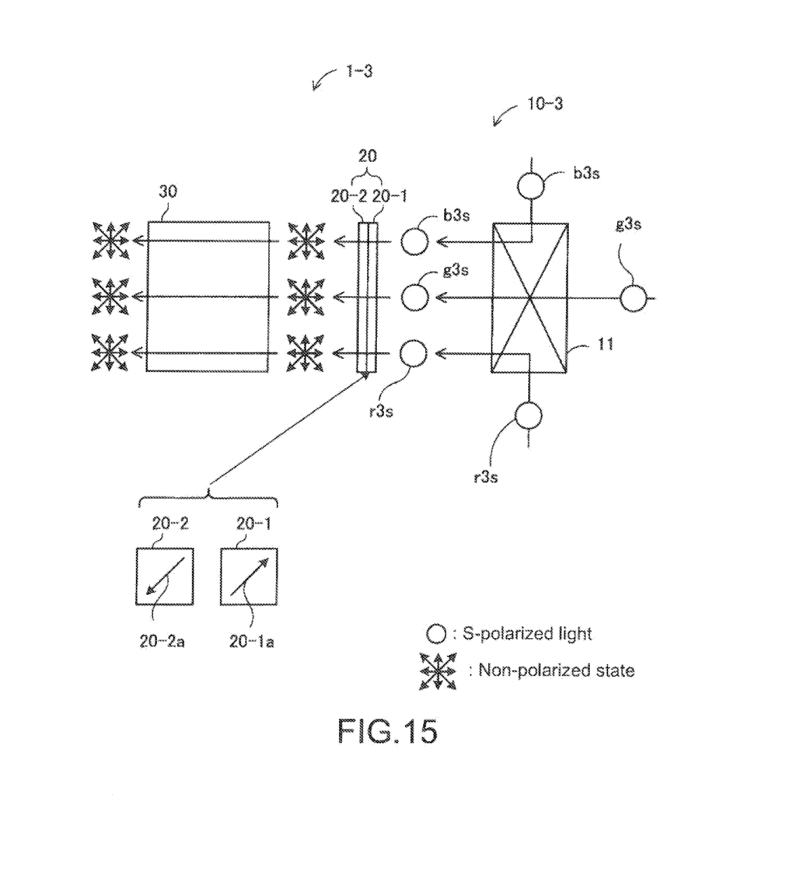

FIG. 15 is a diagram showing an exemplary configuration of a projection apparatus according to an arrangement pattern 3. A projection apparatus 1-3 includes a color synthesis section 10-3, the polarization conversion section 20, and the projection lens 30. The configuration of the polarization conversion section 20 is the same as that described above, and therefore overlapping description will be omitted.

A color synthesis prism 11 of an SSS-model generates combined light by combining red S-polarized light r3s, green S-polarized light g3s, and blue S-polarized light b3s. The red S-polarized light r3s is S-polarized red light, the green S-polarized light g3s is S-polarized green light, and the blue S-polarized light b3s is S-polarized blue light.

The first polarization conversion member 20-1 of the polarization conversion section 20 converts the polarization states of the light emitted from the color synthesis prism 11, i.e., the red S-polarized light r3s, the green S-polarized light g3s, and the blue S-polarized light b3s, into the non-polarized states that are uniform in all directions. The second polarization conversion member 20-2 integrates the light separated by passing through the first polarization conversion member 20-1 into one light again.

The projection lens 30 receives the combined light emitted from the polarization conversion section 20, each color light of the combined light being in the non-polarized state. Then, the projection lens 30 magnifies the combined light to a predetermined magnification for emission. After that, the projection light in the non-polarized state that is uniform in all directions is emitted onto the screen.

With the projection apparatus 1-3 configured as described above, the same effects as those produced by using the projection apparatus 1-1 can be obtained.

### 4-4. Arrangement Pattern 4

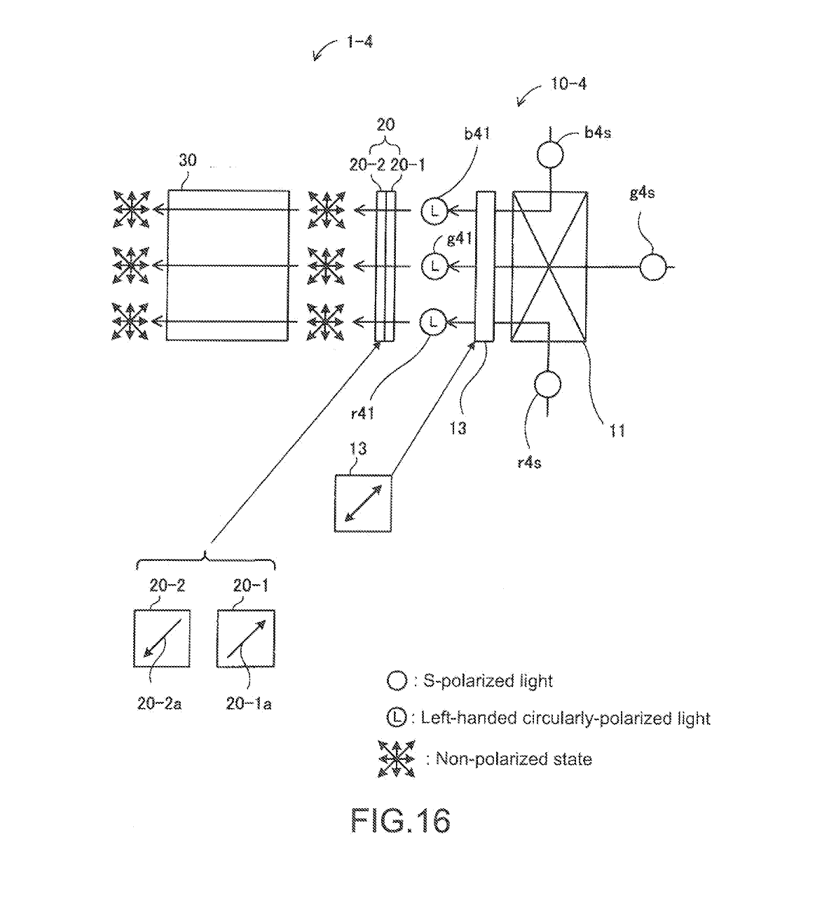

FIG. 16 is a diagram showing an exemplary configuration of a projection apparatus according to an arrangement pattern 4. A projection apparatus 1-4 includes a color synthesis section 10-4, the polarization conversion section 20, and the projection lens 30.

The color synthesis section 10-4 includes a color synthesis prism 11 of an SSS model and a quarter-wave plate 13. The configuration of the polarization conversion section 20 is the same as that described above, and therefore overlapping description will be omitted.

The color synthesis prism 11 generates combined light by combining red S-polarized light r4s, green S-polarized light g4s, and blue S-polarized light b4s. The red S-polarized light r4s is S-polarized red light, the green S-polarized light g4s is S-polarized green light, and the blue S-polarized light b4s is S-polarized blue light.

For prevention of the stray light described above, the quarter-wave plate 13 is disposed on a light-emission side of the color synthesis prism 11 and is so oriented that the optical axis forms an angle of 45° with respect to the incoming polarized light. Then, the quarter-wave plate 13 converts the red S-polarized light r4s into left-handed circularly-polarized light, i.e., red left-handed circularly-polarized light r41, the green S-polarized light g4s into left-handed circularly-polarized light, i.e., green left-handed circularly-polarized light g41, and the blue S-polarized light b4s into left-handed circularly-polarized light, i.e., blue left-handed circularly-polarized light b41.

The first polarization conversion member 20-1 of the polarization conversion section 20 converts the polarization states of the light emitted from the quarter-wave plate 13, i.e., the red left-handed circularly-polarized light r41, the green left-handed circularly-polarized light g41, and the blue left-handed circularly-polarized light b41, into the non-polarized states that are uniform in all directions. The second polarization conversion member 20-2 integrates the light separated by passing through the first polarization conversion member 20-1 into one light again.

The projection lens 30 receives the combined light emitted from the polarization conversion section 20, each color light of the combined light being in the non-polarized state. Then, the projection lens 30 magnifies the combined light to a predetermined magnification for emission. After that, the projection light in the non-polarized state that is uniform in all directions is emitted onto the screen.

With the projection apparatus 1-4 configured as described above, the same effects as those produced by using the projection apparatus 1-1 can be obtained.

### 5. Exemplary Installation Mode of Polarization Conversion Section in Projection Apparatus

Described next, will be the installation mode of the polarization conversion section 20 in the projection apparatus 1.

### 5-1. Installation Mode 1

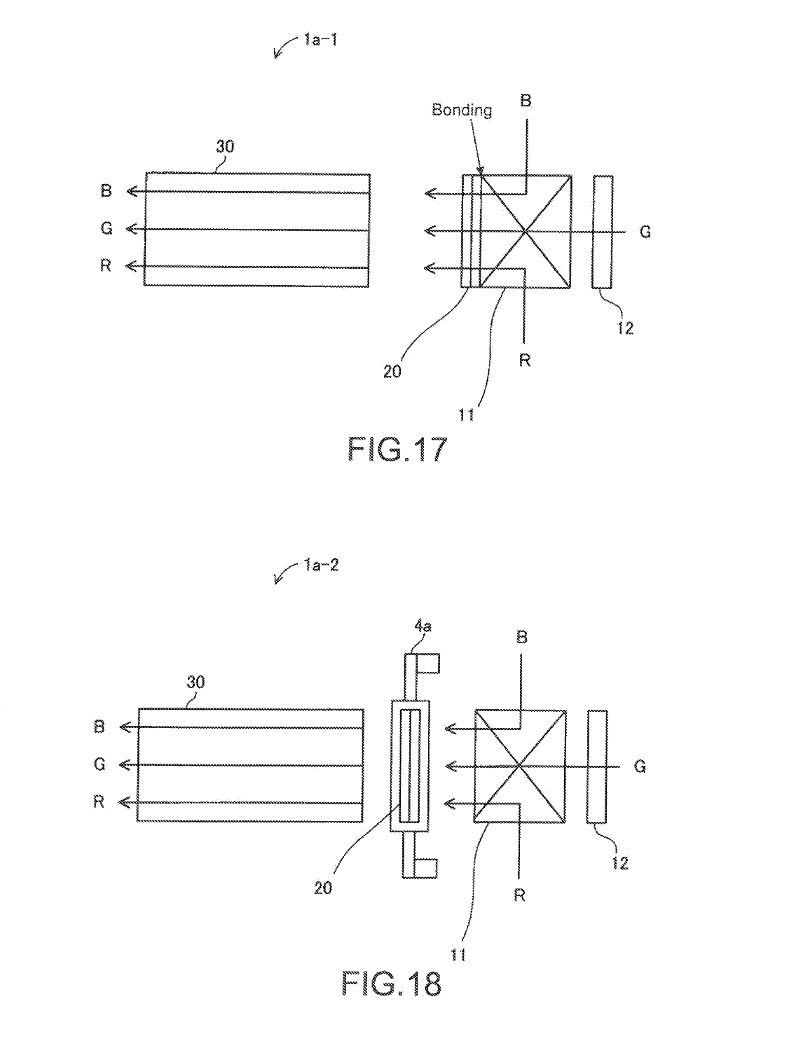

FIG. 17 is a diagram showing an exemplary installation mode in an installation mode 1. A projection apparatus 1a-1 includes a color synthesis prism 11 (of SPS model), the half-wave plate 12, the polarization conversion section 20, and the projection lens 30. The polarization conversion section 20 is formed of the first polarization conversion section 20-1 and the second polarization conversion section 20-2 as described above. In the following description, the first polarization conversion section 20-1 and the second polarization conversion section 20-2 are collectively referred to as the polarization conversion section 20.

On a light-incident side of the color synthesis prism 11 where green light enters, the half-wave plate 12 is disposed. On a light-emission side of the color synthesis prism 11 where combined light exits, the projection lens 30 is disposed. Moreover, between the light-incident side of the projection lens 30 and the light-emission side of the color synthesis prism 11, the polarization conversion section 20 is disposed. In this configuration, the polarization conversion section 20 is formed integrally with the color synthesis prism 11 by being bonded to the light-emission surface of the color synthesis prism 11. It should be noted that in this installation mode, the half-wave plate 12 may not be provided. The color synthesis prism 11 may be of an SPS-model, an SSS-model, or any other model.

### 5-2. Installation Mode 2

FIG. 18 is a diagram showing another exemplary installation mode in an installation mode 2. A projection apparatus 1a-2 includes a color synthesis prism 11 (of SPS-model), the half-wave plate 12, the polarization conversion section 20, and the projection lens 30.

On the light-incident side of the color synthesis prism 11 where green light enters, the half-wave plate 12 is disposed. On the light-emission side of the color synthesis prism 11 where combined light exits, the projection lens 30 is disposed. Moreover, between the light-incident side of the projection lens 30 and the light-emission side of the color synthesis prism 11, a mechanism frame component 4a is provided. The mechanism frame component 4a is a mounting mechanism portion for installing the polarization conversion, section 20.

The polarization conversion section 20 is insertable/removable to/from the mechanism frame component 4a. By being inserted into the mechanism frame component 4a, the polarization conversion section 20 is fixedly disposed between the light-emission side of the color synthesis prism 11 and the light-incident side of the projection lens 30. It should be noted that in this installation mode, the half-wave plate 12 may not be provided. The color synthesis prism 11 may be of an SPS-model, an SSS-model, or any other model.

### 5-3. Installation Mode 3

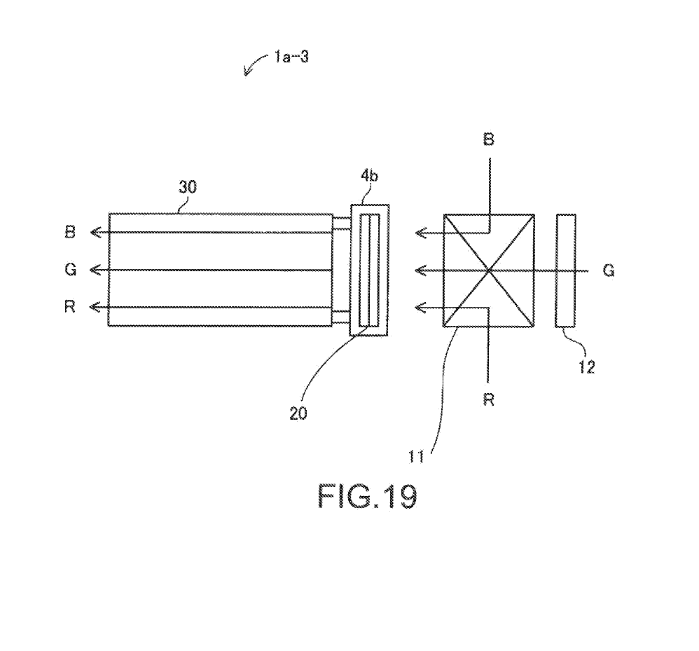

FIG. 19 is a diagram showing another exemplary installation mode in an installation mode 3. A projection apparatus 1a-3 includes a color synthesis prism 11 (of SPS-model), the half-wave plate 12, the polarization conversion section 20, and the projection lens 30.

On the light-incident side of the color synthesis prism 11 where green light enters, the half-wave plate 12 is disposed. On the light-emission side of the color synthesis prism 11 where combined light exits, the projection lens 30 is disposed. Moreover, on the light-incident surface of the projection lens 30, a mechanism frame component 4b is provided. The mechanism frame component 4b is a mounting mechanism portion for installing the polarization conversion section 20.

The projection lens 30 includes a lens shift mechanism that moves the lens to shift vertically and horizontally, for example. The mechanism frame component 4b also follows the shifting movement of the projection lens 30. The polarization conversion section 20 is insertable/removable to/from such a mechanism frame component 4b. By being inserted into the mechanism frame component 4b, the polarization conversion section 20 is disposed in the vicinity of the light-incident surface side of the projection lens 30 while always following the shifting movement of the projection lens 30. It should be noted that in this installation mode, the half-wave plate 12 may riot be provided. The color synthesis prism 11 may be of an SPS-model, an SSS-model, or any other model.

Described next will be a light source for use in the projection apparatus 1. The projection apparatus 1 uses a light source with wide-range-wavelength continuous emission spectrum or a light source with wide-range-wavelength continuous emission spectrum for RGB projection light, for example.

Thus, since a general LCD projector includes a continuous-wavelength light source such as a UHP (Ultra High Performance) lamp or a Xe (xenon) lamp, the functions of the projection apparatus 1 are applicable practically to almost every LCD projector.

### 6. Differences Between Related Art and the Present Disclosure

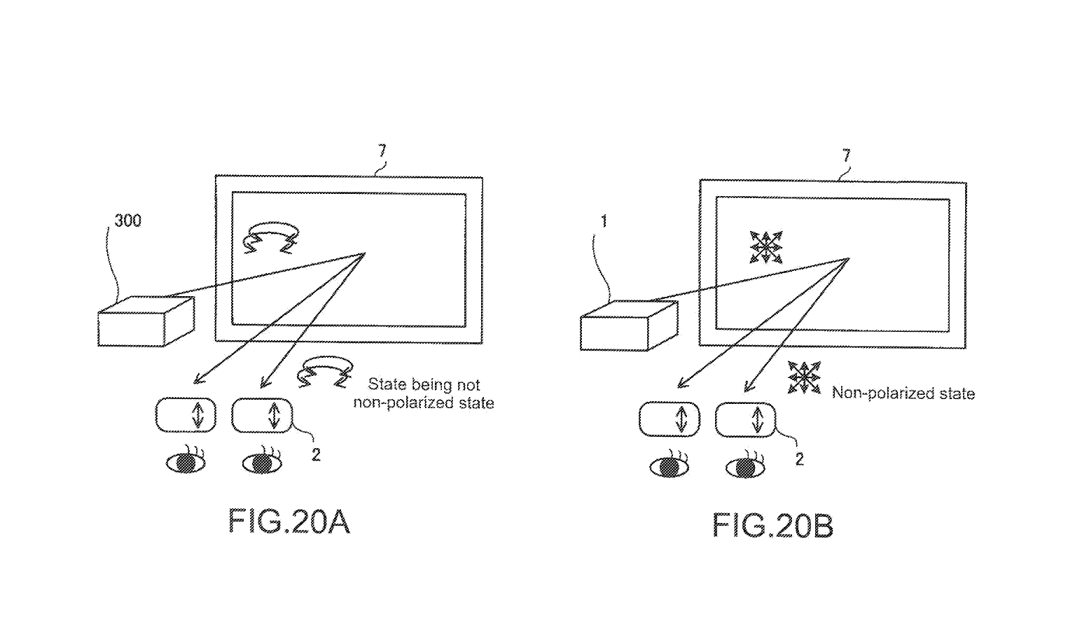

Described next will be differences between a projection apparatus of related art and a projection apparatus according to an embodiment of the present disclosure. FIG. 20A is a conceptual view showing projection by a projection apparatus. In projection light coming from a projection apparatus 300 of related art, light entering the screen 7 and light reflected on the screen 7 are not put in the non-polarized state. On the other hand, in projection light coming from the projection apparatus 1 according to the embodiment of the present disclosure shown in FIG. 20B, light entering the screen 7 and light reflected on the screen 7 are both put in the non-polarized state that is uniform in all directions.

As described above, according to the projection apparatus 1, the polarization conversion section 20 is disposed between the light-emission side of the color synthesis prism 11 where combined light exits and the light-incident side of the projection lens 30. Thus, compared with the configuration including the polarization conversion section 20 on the light-emission side of the projection lens 30, the polarization conversion section 20 disposed closer to the color synthesis prism 11, i.e., on the light-emission side thereof, allows RGB projection light to be entirely put in the non-polarized state that is uniform in all directions.

Thus, the color unevenness of 3D images seen through the 3D glasses 2 when the 3D glasses 2 are not tilted can be completely eliminated. Moreover, with the 3D glasses 2 having a tilt of about ±25° (expected use range for customers), for example, the color unevenness and brightness reduction of the 3D images through the 3D glasses 2 can be completely eliminated.

Further, the projection apparatus 1 only needs to be provided with the polarization conversion section 20 on the light-emission side of the color synthesis prism 11 and therefore has high compatibility with any other LCD projectors and is excellent in serviceability. For example, the projection apparatus 1 is compatible with any types of LCD projectors including a reflective LCD, a transmissive LCD, and the like.

Further, since the polarization state of the combined light emitted from the color synthesis prism 11 is also converted into the non-polarized state by the polarization conversion section 20, the color unevenness that is liable to occur In the SPS model and the brightness unevenness that is liable to occur in the SSS model do not occur. Thus, any color synthesis prism of any synthesis model can be used.

Further, since the polarization state of light is converted into the non-polarized state by passing through the polarization conversion section 20, non-uniform polarization caused due to the passage of the light through the projection lens 30 can be eliminated. Thus, a plastic lens that causes large non-uniform polarization can be used as the projection lens 30. In other words, manufacturing costs can be reduced.

Further, since the polarization state of light to be emitted onto the screen 7 is converted into the non-polarized state, the color unevenness or the brightness unevenness caused due to polarization characteristics of the screen 7 does not occur. Therefore, any screen having any polarization characteristics can be used without problems. For example, silver screens, beaded screens, and matte screens can also be used.

Further, the light separated by passing through the first polarization conversion member 20-1 formed of the uniaxial crystal is also integrated into one light by the second polarization conversion member 20-2 formed of the uniaxial crystal. Thus, an image projected onto the 7 screen is less reduplicated or the outline of the image is less blurred. In other words, the quality of 2D images and 3D images can be significantly improved.

Further, the use of the uniaxial crystal as the polarization conversion section 20 can lead to cost reduction compared with the case where a wavelength-selective half-wave plate or a uniaxial organic material is used. In particular, the wavelength-selective half-wave plate is more expensive when it is used for a larger area. Therefore, the use of the uniaxial crystal can lead to cost reduction to a large degree. Additionally, the uniaxial crystal is optical glass and thus has high physical strength and high reliability. Further, the uniaxial crystal is not a sheet- or film-shaped organic material, and therefore its focus performance is not lowered even when the uniaxial crystal is installed between LCD-projection lenses.

### 7. Various Modified Examples

It should be noted that the polarization conversion section 20 is formed of the uniaxial crystal in the embodiment described above, but the polarization conversion section 20 may be a uniaxial optical element. Alternatively, a uniaxial organic material may be used therefor.

Further, in the arrangement patterns described with reference to FIGS. 13 to 16, the case where the slow axis 20-1a of the first polarization conversion member 20-1 has an angle of 45° and the slow axis 20-2a of the second polarization conversion member 20-2 has an angle of 225° has been exemplified, but the arrangement patterns are not limited thereto. The slow axis 20-1a of the first polarization conversion member 20-1 and the slow axis 20-2a of the second polarization conversion member 20-2 may have any angle as long as the angle is tilted by 45° with respect to the oscillation direction of combined light emitted from the color synthesis prism 11. Specifically, in the case where the light emitted from the color synthesis prism 11 is S-polarized light or P-polarized light, the slow axis may have any angle of 45°, 135°, 225°, or 315°.

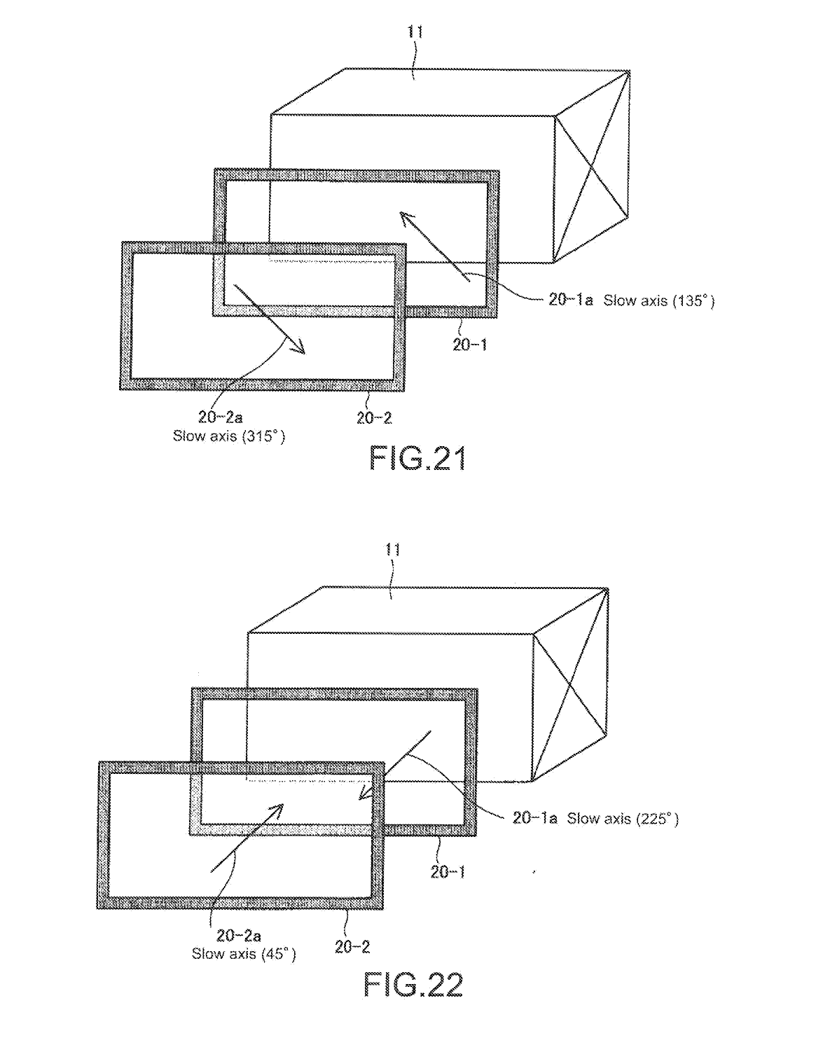

FIG. 21 is a perspective view showing an exemplary configuration in the case where the slow axis 20-1a of the first polarization conversion member 20-1 is set to have an angle of 135°. In the case where the slow axis 20-1a of the first polarization conversion member 20-1 is set to have an angle of 135°, with the setting of the slow axis 20-2a of the second polarization conversion member 20-2 to have an angle of 315°, the light separated by the first polarization conversion member 20-1 is integrated into one light again by the second polarization conversion member 20-2. FIG. 22 is a perspective view showing an exemplary configuration in the case where the slow axis 20-1a of the first polarization conversion member 20-1 is set to have an angle of 225°. In this case, the slow axis 20-2a of the second polarization conversion member 20-2 only needs to have an angle of 45°, which is different in direction by 180°.

Further, the angle of the slow axis 20-1a of the first polarization conversion member 20-1 with respect to the amplitude direction of the incoming polarized light may not be 45°, and as long as the angle is different from the angle of the amplitude direction of the incoming polarized light, certain effects can be obtained. The amplitude direction of the incoming polarized light is a vertical direction (90° or 270°) with respect to the incident surface in the case of S-polarized light or is a horizontal direction (0° or 180°) with respect to the incident surface in the case of P-polarized light. Therefore, in the case where the light emitted from the color synthesis prism 11 is S-polarized light or P-polarized light, the slow axis 20-1a of the first polarization conversion member 20-1 is set to have any angle other than 0°, 90°, 180°, and 270° so that the quality of images can be improved at a certain level.

Further, the present disclosure is also applicable to the case where the light emitted from the color synthesis prism 11 is circularly-polarized light. In this case, the slow axis 20-1a of the first polarization conversion member 20-1 may have any angle. When the slow axis 20-2a of the second polarization conversion member 20-2 is set to be different from the slow axis 20-1a of the first polarization conversion member 20-1 by 180°, the color unevenness and brightness reduction of 3D images and the color unevenness of 2D images can be eliminated.

It should be noted that the present disclosure can have the following configurations.

(1) A projection apparatus, including:

a color synthesis section configured to combine light in three primary colors of red light, green light, and blue light and emit combined light;

a polarization conversion section including
a first polarization conversion member having a slow axis with an angle other than angles of 0°, 90°, 180°, and 270°, and
a second polarization conversion member having a slow axis with an angle that is opposite to the slow axis of the first polarization conversion member by 180°; and

a projection lens configured to emit light output from the polarization conversion section.

(2) The projection apparatus according to (1), in which

each of the first polarization conversion member and the second polarization conversion member of the polarization conversion section includes an optical element having one optic axis.

(3) The projection apparatus according to (1) or (2), in which

the slow axis of the first polarization conversion member has an angle tilted by 45° with respect to an oscillation direction of light emitted from the color synthesis section.

(4) The projection apparatus according to any one of (1) to (3), in which

each of the first polarization conversion member and the second polarization conversion member of the polarization conversion section includes a uniaxial crystal.

(5) The projection apparatus according to any one of (1) to (4), in which

the polarization conversion section is disposed on a light-emission side of the color synthesis section.

(6) The projection apparatus according to any one of (1) to (5), in which

the color synthesis section includes
a color synthesis prism, and
a half-wave plate disposed on a light-incident side of the color synthesis prism where green light enters, the half-wave plate being configured to convert S-polarized green light into P-polarized green light, the color synthesis prism being configured to combine red S-polarized light being S-polarized red light, green P-polarized light being the P-polarized green light, and blue S-polarized light being S-polarized blue light, and

the polarization conversion section is configured to convert the red S-polarized light, the green P-polarized light, and the blue S-polarized light to have a non-polarized state.

(7) The projection apparatus according to any one of (1) to (5), in which

the color synthesis section includes
a color synthesis prism,
a half-wave plate disposed on a light-incident side of the color synthesis prism where green light enters, and
a quarter-wave plate disposed between a light-incident side of the polarization conversion section and a light-emission side of the color synthesis prism, the half-wave plate being configured to convert S-polarized green light into P-polarized green light, the color synthesis prism being configured to combine red S-polarized light being S-polarized red light, green P-polarized light being the P-polarized green light, and blue S-polarized light being S-polarized blue light, the quarter-wave plate being configured to convert the red S-polarized light into red left-handed circularly-polarized light being left-handed circularly-polarized light, the green P-polarized light into green right-handed circularly-polarized light being right-handed circularly-polarized light, and the blue S-polarized light into blue left-handed circularly-polarized light being left-handed circularly-polarized light, and

the polarization conversion section is configured to convert each of the red left-handed circularly-polarized light, the green right-handed circularly-polarized light, and the blue left-handed circularly-polarized light to have a non-polarized state.

(8) The projection apparatus according to any one of (1) to (5), in which

the color synthesis section includes a color synthesis prism, the color synthesis prism being configured to combine red S-polarized light being S-polarized red light, green S-polarized light being S-polarized green light, and blue S-polarized light being S-polarized blue light, and

the polarization conversion section is configured to convert the red S-polarized light, the green S-polarized light, and the blue S-polarized light to have, a non-polarized state.

(9) The projection apparatus according to any one of (1) to (5), in which

the color synthesis section includes
a color synthesis prism, and
a quarter-wave plate disposed between a light-incident side of the polarization conversion section and a light-emission side of the color synthesis prism, the color synthesis prism being configured to combine red S-polarized light being S-polarized red light, green S-polarized light being S-polarized green light, and blue S-polarized light being S-polarized blue light, the quarter-wave plate being configured to convert the red S-polarized light into red left-handed circularly-polarized light being left-handed circularly-polarized light, the green S-polarized light into green left-handed circularly-polarized light being left-handed circularly-polarized light, and the blue S-polarized light into blue left-handed circularly-polarized light being left-handed circularly-polarized light, and

the polarization conversion section is configured to convert each of the red left-handed circularly-polarized light, the green left-handed circularly-polarized light, and the blue left-handed circularly-polarized light to have a non-polarized state.

(10) The projection apparatus according to any one of (1) to (9), in which

the polarization conversion section is formed integrally with the color synthesis prism by being bonded to a light-emission surface of the color synthesis prism included in the color synthesis section.

(11) The projection apparatus according to any one of (1) to (9), in which

the polarization conversion section is fixedly disposed between the color synthesis prism and the projection lens via an attachment mechanism section, the attachment mechanism section being disposed between a light-emission side of the color synthesis prism included in the color synthesis section and a light-incident side of the projection lens.

(12) The projection apparatus according to any one of (1) to (9), in which

the polarization conversion section is disposed in a vicinity of a surface of the projection lens on a light-incident side and is configured to follow a shifting movement of the projection lens.

In addition, the embodiment described above can be variously modified by a person skilled in the art and is not limited to the exact configurations and application examples described above.

The present disclosure contains subject matter related to that disclosed in Japanese Priority Patent Application JP 2012-189863 filed in the Japan Patent Office on Aug. 30, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A projection apparatus, comprising:
a color synthesis section configured to combine light in three primary colors of red light, green light, and blue light and emit combined light;
a polarization conversion section including
a first polarization conversion member having a slow axis with an angle other than angles of 0°, 90°, 180°, and 270°, and
a second polarization conversion member having a slow axis with an angle that is opposite to the slow axis of the first polarization conversion member by 180°; and
a projection lens configured to emit light output from the polarization conversion section.

2. The projection apparatus according to claim 1, wherein
each of the first polarization conversion member and the second polarization conversion member of the polarization conversion section includes an optical element having one optic axis.

3. The projection apparatus according to claim 2, wherein
the slow axis of the first polarization conversion member has an angle tilted by 45° with respect to an oscillation direction of light emitted from the color synthesis section.

4. The projection apparatus according to claim 3, wherein
each of the first polarization conversion member and the second polarization conversion member of the polarization conversion section includes a uniaxial crystal.

5. The projection apparatus according to claim 4, wherein
the polarization conversion section is disposed on a light-emission side of the color synthesis section.

6. The projection apparatus according to claim 3, wherein
the color synthesis section includes
a color synthesis prism configured to combine the light in three primary colors and emit combined light, and
a half-wave plate disposed on a light-incident side of the color synthesis prism where green light enters, the half-wave, plate being configured to convert S-polarized green light into P-polarized green light, the color synthesis prism being configured to combine red S-polarized light being S-polarized red light, green P-polarized light being the P-polarized green light, and blue S-polarized light being S-polarized blue light, and
the polarization conversion section is configured to convert the red S-polarized light, the green P-polarized light, and the blue S-polarized light to have a non-polarized state.

7. The projection apparatus according to claim 3, wherein
the color synthesis section includes
a color synthesis prism configured to combine the light in three primary colors and emit combined light,
a half-wave plate disposed on a light-incident side of the color synthesis prism where green light enters, and
a quarter-wave plate disposed between a light-incident side of the polarization conversion section and a light-emission side of the color synthesis prism, the half-wave plate being configured to convert S-polarized green light into P-polarized green light, the color synthesis prism being configured to combine red S-polarized light being S-polarized red light, green P-polarized light being the P-polarized green light, and blue S-polarized light being S-polarized blue light, the quarter-wave plate being configured to convert the red S-polarized light into red left-handed circularly-polarized light being left-handed circularly-polarized light, the green P-polarized light into green right-handed circularly-polarized light being right-handed circularly-polarized light, and the blue S-polarized light into blue left-handed circularly-polarized light being left-handed circularly-polarized light, and
the polarization conversion section is configured to convert each of the red left-handed circularly-polarized light, the green right-handed circularly-polarized light, and the blue left-handed circularly-polarized light to have a non-polarized state.

8. The projection apparatus according to claim 3, wherein
the color synthesis section includes a color synthesis prism configured to combine the light in three primary colors and emit combined light, the color synthesis prism being configured to combine red S-polarized light being S-polarized red light, green S-polarized light being S-polarized green light, and blue S-polarized light being S-polarized blue light, and
the polarization conversion section is configured to convert the red S-polarized light, the green S-polarized light, and the blue S-polarized light to have a non-polarized state.

9. The projection apparatus according to claim 3, wherein
the color synthesis section includes
a color synthesis prism, and
a quarter-wave plate disposed between a light-incident side of the polarization conversion section and a light-emission side of the color synthesis prism, the color synthesis prism being configured to combine red S-polarized light being S-polarized red light, green S-polarized light being S-polarized green light, and blue S-polarized, light being S-polarized blue light, the quarter-wave plate being configured to convert the red S-polarized light into red left-handed circularly-polarized light being left-handed circularly-polarized light, the green S-polarized light into green left-handed circularly-polarized light being left-handed circularly-polarized light, and the blue S-polarized light into blue left-handed circularly-polarized light being left-handed circularly-polarized light, and
the polarization conversion section is configured to convert each of the red left-handed circularly-polarized light, the green left-handed circularly-polarized light, and the blue left-handed circularly-polarized light to have a non-polarized state.

10. The projection apparatus according to claim 3, wherein
the polarization conversion section is formed integrally with the color synthesis prism by being bonded to a light-emission surface of the color synthesis prism included in the color synthesis section.

11. The projection apparatus according to claim 3, wherein
the polarization conversion section is fixedly disposed between the color synthesis prism and the projection lens via an attachment mechanism section, the attachment mechanism section being disposed between a light-emission side of the color synthesis prism included in the color synthesis section and a light-incident side of the projection lens.

12. The projection apparatus according to claim 3, wherein
the polarization conversion section is disposed in a vicinity of a surface of the projection lens on a light-incident side and is configured to follow a shifting movement of the projection lens.
